(19) United States
(12) Patent Application Publication
(10) Pub. No.: US 2026/0369732 A1
(43) Pub. Date: Nov. 19, 2026

(54) BATTERY APPARATUS AND ELECTRICAL DEVICE

(71) Applicant: CONTEMPORARY AMPEREX TECHNOLOGY CO., LIMITED, Ningde (CN)

(72) Inventors: Cancan LI, Ningde (CN); Jun MA, Ningde (CN); Jiangming LIU, Ningde (CN)

(21) Appl. No.: 19/343,508

(22) Filed: Sep. 29, 2025

Related U.S. Application Data
(63) Continuation of application No. PCT/CN2025/104434, filed on Jun. 27, 2025.

(30) Foreign Application Priority Data
May 16, 2025 (CN) 202510637181.7

(51) Int. Cl. H01M 10/6556; H01M 10/613; H01M 10/6567; H01M 50/209; H01M 50/242; H01M 50/342

(52) U.S. Cl. CPC H01M 10/6556; H01M 10/613; H01M 10/6567; H01M 50/209; H01M 50/242; H01M 50/3425; H01M 2220/20

(57) ABSTRACT

A battery apparatus includes a battery cell assembly including a plurality of battery cells arranged along a first direction and a box including first and second box bodies. The first and second box bodies jointly define an accommodating space, in which the battery cell assembly is located. The first box body includes a frame and a plurality of structural beams. The plurality of structural beams are arranged at intervals along a second direction, and are connected to the frame. The frame has a flow collecting channel. The structural beams each have a heat exchange flow channel inside, the heat exchange flow channels of two adjacent structural beams are communicated through the flow collecting channel. The first direction intersects with the second direction, and the plane where the first direction and the second direction are located intersects with a height direction of the box.

### CROSS-REFERENCE TO RELATED APPLICATIONS

The present application is a continuation of International Application No. PCT/CN2025/104434, filed on Jun. 27, 2025, which claims priority to Chinese patent application 202510637181.7 filed on May 16, 2025 and titled “BATTERY APPARATUS AND ELECTRICAL DEVICE”, which are incorporated herein by reference in their entirety.

### TECHNICAL FIELD

The present application relates to the technical field of batteries, and specifically relates to a battery apparatus and an electrical device.

### BACKGROUND

The battery box has an integrated water-cooling structure, which is composed of a combination of a plurality of profile bottom plates that completely cover the bottom of the modular battery cell. All profile bottom plates are fixed by means of welding. The welding volume is large, the process is difficult, and the profile extrusion process is difficult to achieve complex flow channels and has low flexibility.

### SUMMARY

In view of the above problems, the present application provides a battery apparatus and an electrical device, where two adjacent structural beams are connected to a flow collector unit, which can simplify the bottom structure of the box, reduce the welding area, and simplify the manufacturing difficulty of the box.

In a first aspect, the present application provides a battery apparatus, including:
a battery cell assembly including a plurality of battery cells arranged along a first direction; and
a box including a first box body and a second box body, where the first box body and the second box body jointly define an accommodating space, the battery cell assembly is located in the accommodating space, the first box body has a flow collecting channel, the first box body includes a frame and a plurality of structural beams, the plurality of structural beams are arranged at intervals along a second direction, the plurality of structural beams are respectively connected to the frame, the structural beams each have a heat exchange flow channel inside, the heat exchange flow channels of two adjacent structural beams are communicated through the flow collecting channel, the first direction intersects with the second direction, and the plane where the first direction and the second direction are located intersects with a height direction of the box.

A plurality of structural beams are arranged at intervals along the second direction. In welding, compared with a conventional battery apparatus in which a water-cooling plate formed by a combination of a plurality of profile bottom plates is connected to a frame, the welding area can be reduced, the production efficiency is improved, and the manufacturing cost is reduced, the weight of the box is reduced, and the use of materials is saved. In addition, the structural beam has a heat exchange flow channel inside, the first box body has a flow collecting channel, and the heat exchange flow channels of two adjacent structural beams are connected through the flow collecting channel. The heat exchange flow channels of the two adjacent structural beams can be connected in series or in parallel as needed, so that the flow channels can be flexibly designed as needed, thereby reducing the complexity of the structure.

In some embodiments, the first box body includes a flow collector member, the frame includes two first side beams spaced apart along the first direction, at least one end of the structural beam along the first direction is connected with the flow collector member, the structural beam is connected to the first side beam through the flow collector member, the flow collector member includes at least one flow collector unit, and the flow collector unit has a flow collecting channel inside.

The structural beam is connected to the first side beam through the flow collector member. During assembly, the flow collector member can be connected to the first side beam first, and then the structural beam can be connected to the flow collector member to achieve part-by-part assembly to facilitate the installation. In addition, the flow collector member is provided as a separate component to facilitate the production of the flow collecting channel.

In some embodiments, the structural beam is welded to the flow collector member; and/or the frame is welded to the flow collector member.

As a result, the complex flow channel connection structure in the conventional profile bottom plate splicing is eliminated, the number of welds and the welding area are significantly reduced, the possibility of leakage caused by the large number of welds in the conventional profile splicing is reduced, and the sealing is improved. In addition, rigid connection is formed through welding of the structural beam to the frame via the flow collector member, which improves the overall vibration and impact resistance of the box and is beneficial for increasing the dominant frequency of the battery apparatus.

In some embodiments, the flow collector member further includes a connecting portion, and both ends of the flow collector unit along the second direction are respectively connected with the connecting portions. The end of the structural beam along the first direction is welded to the connecting portion; and/or the first side beam is welded to the connecting portion.

The connecting portion serves as an intermediate transition component and is welded to the structural beam and/or the first side beam, so as to facilitate the manufacture of the first box body.

In some embodiments, the flow collector member further includes an insertion portion, and both ends of the flow collector unit along the second direction are respectively provided with the insertion portions. The insertion portion at one end of the flow collector unit along the second direction is a first insertion portion, and the insertion portion at the other end of the flow collector unit along the second direction is a second insertion portion. The first insertion portion is inserted into the heat exchange flow channel of one of the two adjacent structural beams, and the second insertion portion is inserted into the heat exchange flow channel of the other one of the two adjacent structural beams.

The insertion portion inserted into the heat exchange flow channel forms an internal support structure. The welding of the flow collector unit to the structural beam can be achieved by friction welding. Under the pressure of friction welding, the insertion portion can reduce the possibility of plastic deformation or collapse of the thin-walled heat exchange flow channel due to squeezing, so that better sealing is provided during the friction welding process and the possibility of the heat exchange flow channel being crushed can be reduced. After welding, the heat exchange flow channel and the flow collecting channel are in smoother communication. In addition, since the structural beam is subjected to the weight from the battery cell, part of the stress can be dispersed through the insertion portion to reduce the stress at the welding point between the flow collector unit and the structural beam, thereby reducing the possibility of the structural beam breaking due to excessive force at the weld position, and improving the reliability of the structural beam at the connection position of the flow collector member.

In some embodiments, the insertion depth of the insertion portion into the heat exchange flow channel along the second direction is H1, and the value of H1 ranges from 5 mm to 10 mm.

The insertion depth in a range of 5 to 10 mm enables the insertion portion to provide sufficient supporting force during the friction welding process to disperse the stress during the welding process, while avoiding excessive waste of materials and saving the manufacturing cost. In addition, when the structural beam is subjected to the weight from the battery cell or the battery apparatus is in a vibrating environment, limiting H1 within the above numerical range can disperse the stress, reduce the possibility of the structural beam breaking due to excessive force at the weld position, and improve the reliability of the structural beam at the connection position of the flow collector member.

In some embodiments, there are a plurality of flow collecting channels, and the plurality of flow collecting channels are arranged at intervals along the second direction. A support rib is formed between two adjacent flow collecting channels, and the support rib extends from both ends of the flow collecting channels along the second direction. The part of the support rib extending from the end of the flow collecting channel along the second direction is configured as an insertion portion.

The provision of the support rib can reduce the possibility of the flow collecting channel being crushed during the friction welding process, so that the flow collecting channel and the heat exchange flow channel can be in smooth communication after welding, thereby improving the welding quality.

In some embodiments, the dimension of the flow collecting channel along the first direction is W1, and the value of W1 ranges from 4 mm to 10 mm.

As such, when the flow collector unit is friction welded to the frame, the possibility of the flow collecting channel being crushed due to excessive friction welding pressure can be reduced, and the welding quality can be improved, so that the flow collecting channel and the heat exchange flow channel can be in smooth communication after welding.

In some embodiments, the flow collector unit includes a main body portion and a tube portion, the main body portion has an accommodating cavity inside, the accommodating cavity runs through both ends of the main body portion along the second direction, the tube portion is located in the accommodating cavity, both ends of the tube portion extend from both ends of the main body portion along the second direction, the part of the tube portion extending from the main body portion is configured as an insertion portion, the tube portion has a flow collecting channel inside, and the flow collecting channel runs through both ends of the tube portion.

During friction welding, the tube portion can provide support for the heat exchange flow channel to reduce the possibility of the flow collecting channel being crushed.

In some embodiments, the strength of the tube portion is greater than that of the main body portion. As the strength of the tube portion is greater than that of the main body portion, the possibility of the flow collecting channel being crushed can be reduced during friction welding. At the same time, due to the greater strength of the tube portion, the flow area of the flow collecting channel can be made larger to reduce the flow resistance of the heat exchange medium.

In some embodiments, the flow collector member further includes a connecting portion, both ends of the flow collector unit along the second direction are respectively connected with the connecting portions, and the connecting portions are respectively connected to the end of the structural beam and the frame.

The connecting portion serves as an intermediate transition component between the structural beam and the frame. After the connecting portion is connected to the frame, the connecting portion can be connected to the structural beam. The section-by-section assembly can facilitate the assembly operation.

In some embodiments, a protrusion is provided on the side of the connecting portion facing the structural beam, and the protrusion is inserted into the heat exchange flow channel.

The protrusion inserted into the heat exchange flow channel forms a support structure. The welding of the flow collector member to the structural beam can be achieved by friction welding. Under the pressure of friction welding, the protrusion can reduce the possibility of plastic deformation or collapse of the thin-walled heat exchange flow channel due to squeezing, so that better sealing is provided during the friction welding process and the possibility of the heat exchange flow channel being crushed can be reduced. After welding, the heat exchange flow channel and the flow collecting channel are in smoother communication. In addition, since the structural beam is subjected to the weight from the battery cell, part of the stress can be dispersed through the protrusion to reduce the stress at the welding point between the flow collector unit and the structural beam, thereby reducing the possibility of the structural beam breaking due to excessive force at the weld position, and improving the reliability of the structural beam at the connection position of the flow collector member.

In some embodiments, the dimension of the protrusion along the first direction is H2, and the value of H2 ranges from 5 mm to 10 mm.

By setting H2 within the above range, the protrusion is enabled to provide sufficient supporting force during the friction welding process to disperse the stress during the welding process, while avoiding excessive waste of materials and saving the manufacturing cost. In addition, when the structural beam is subjected to the weight from the battery cell or the battery apparatus is in a vibrating environment, limiting H2 within the above numerical range can disperse the stress, reduce the possibility of the structural beam breaking due to excessive force at the weld position, and improve the reliability of the structural beam at the connection position of the flow collector member.

In some embodiments, there are a plurality of flow collector units, two adjacent flow collector units are spaced apart along the second direction, and the two adjacent flow collector units are connected via the connecting portion.

In contrast to the method of connecting each flow collector unit to the frame individually, a plurality of flow collector units are integrated into an integral part. In this way, it is only needed to connect the integral part to the frame, and then connect the flow collector units to the structural beam one by one, which saves the time of installing a plurality of flow collector units to the frame individually and improves assembly efficiency. At the same time, it can reduce the installation deviation caused by installing the flow collector units individually.

In some embodiments, the frame includes a first side beam, which is connected to the flow collector member and has a first abutting surface that abuts against the flow collector member along a first direction. Along the first direction, the minimum distance between the heat exchange flow channel and the first abutting surface is Lmin, and the value of Lmin ranges from 5 mm to 15 mm.

When the flow collector member and the frame are friction welded, setting Lmin within the above range can reduce the possibility of the heat exchange flow channel being crushed due to friction welding, thereby improving the welding quality.

In some embodiments, the frame includes two first side beams spaced apart along the first direction, the structural beam is directly welded to the first side beams, and at least one of the first side beams has a flow collecting channel inside.

Directly connecting the structural beam to the first side beam can reduce the welding area, reduce the manufacturing cost, and improve the production efficiency of the battery apparatus, while reducing the complexity of the structure and facilitating manufacturing.

In some embodiments, the heat exchange flow channels inside the plurality of structural beams are communicated in series or in parallel to form a heat exchange flow path, the heat exchange flow path has a first interface and a second interface, one of the first interface and the second interface is configured to allow a heat exchange medium to flow in, and the other one of the first interface and the second interface is configured to allow a heat exchange medium to flow out.

The heat exchange flow channels inside the plurality of structural beams are communicated in series, which can prolong the heat exchange time and achieve more sufficient heat transfer at an unchanged flow rate, and has the characteristics of low resistance and small pressure drop. The heat exchange flow channels inside the plurality of structural beams are communicated in parallel, which can reduce the pressure loss, and the synchronous cooling of the parallel branches makes the inlet temperatures of various branches of the heat exchange flow path consistent, which is beneficial for reducing the temperature difference between different areas of the battery cells and making the temperatures of different battery cells more uniform.

In some embodiments, there are more than three structural beams, the heat exchange flow channels inside the plurality of structural beams are communicated in series and in parallel to form a heat exchange flow path, the heat exchange flow path has a first interface and a second interface, one of the first interface and the second interface is configured to allow a heat exchange medium to flow in, and the other one of the first interface and the second interface is configured to allow a heat exchange medium to flow out.

The heat exchange flow channels inside the plurality of structural beams are communicated in series and in parallel, which on the one hand, in the case of communication in series, can prolong the heat exchange time at an unchanged flow rate, achieve more sufficient heat transfer, and has the characteristics of low resistance and small pressure drop; on the other hand, in the case of communication in parallel, can reduce the pressure loss, and the synchronous cooling of the parallel branches makes the inlet temperatures of various branches of the heat exchange flow path consistent, which is beneficial for reducing the temperature difference between different areas of the battery cells.

In some embodiments, the first box body further includes a connecting tube, one of the two outermost structural beams along the second direction is the first structural beam, and the other one of the two outermost structural beams along the second direction is the second structural beam, and the heat exchange flow channel of the first structural beam is in communication with the heat exchange flow channel of the second structural beam through the connecting tube.

As such, by providing the connecting tube, the plurality of structural beams can realize the layout of complex flow paths in series and parallel, which reduces the complexity of the structure compared with the conventional complex flow paths using water-cooling plates.

In some embodiments, one of the structural beam between the two outermost structural beams along the second direction and the connecting tube is provided with a first interface, and the other one of the structural beam between the two outermost structural beams along the second direction and the connecting tube is provided with a second interface.

Thus, the first interface and the second interface can be provided in the structural beam and the connecting tube, and a variety of different heat exchange flow paths can be realized, which can be adjusted according to the operating temperature of the battery apparatus, thereby achieving better heat exchange effect.

In some embodiments, the frame includes two first side beams spaced apart along the second direction, one of the plurality of structural beams is located in the middle of the two first side beams, and the structural beam located in the middle of the two first side beams is provided with the first interface.

When the battery apparatus is operating, the temperature of the battery cell corresponding to the structural beam in the middle area is more concentrated and higher. Through the above structure, the heat exchange medium can generally enter from the structural beam in the middle area, flow through the outermost structural beam, and then flow out from the structural beam in the middle area, so that the heat exchange is more uniform, the overall temperature gradient is reduced, and the overall heat dissipation is improved.

In a second aspect, the present application provides an electrical device, including the battery apparatus in the first aspect, the battery apparatus being used to supply electric energy to the electrical device.

Since the electrical device includes all the technical features of the battery apparatus in the first aspect, the effects are the same as those described above and will not be described in detail here.

The foregoing description is merely an overview of the technical solutions in the present application. In order that technical means of the present application can be understood more clearly so that the technical means can be implemented according to content of the specification, and in order that the foregoing and other objectives, features, and advantages of the present application can be understood more clearly, specific embodiments of the present application are described below.

### BRIEF DESCRIPTION OF DRAWINGS

By reading the detailed description of the embodiments below, various other advantages and benefits will become apparent to those of ordinary skill in the art. The drawings are used for the purpose of illustrating some embodiments only and are not to be considered a limitation to the present application. In addition, throughout the accompanying drawings, the same reference numeral is used to represent the same component. In the drawings:

FIG. 1 is an exploded view of a battery apparatus of some embodiments of the present application;

FIG. 2 is a structural view of an embodiment of a first box body in a battery apparatus of some embodiments of the present application;

FIG. 3 is a sectional view taken along A-A in FIG. 2;

FIG. 4 is a partial exploded view of a first embodiment of a first box body in a battery apparatus of some embodiments of the present application;

FIG. 5 is a sectional view taken along B-B in FIG. 2;

FIG. 6 is a partial exploded view of a second embodiment of a first box body in a battery apparatus of some embodiments of the present application;

FIGS. 7 to 9 are structural views of different embodiments of a first box body in a battery apparatus of some embodiments of the present application, where arrows in the figures indicate flow directions of the heat exchange flow path;

FIG. 10 is a structural view of a third embodiment of a first box body in a battery apparatus of some embodiments of the present application;

FIG. 11 is a sectional view taken along C-C in FIG. 10;

FIG. 12 is an exploded view of a battery apparatus in some embodiments of the present application;

FIG. 13 is a structural view of a battery apparatus of some embodiments of the present application;

FIG. 14 is a sectional view taken along D-D in FIG. 13;

FIG. 15 is a partial structural view of a battery apparatus of some embodiments of the present application;

FIGS. 16-18 are sectional views of different embodiments of the battery apparatus taken along E-E in FIG. 15;

FIG. 19 is a structural view of an embodiment of a structural beam in a battery apparatus of some embodiments of the present application;

FIG. 20 is an exploded view of a battery apparatus of some embodiments of the present application;

FIG. 21 is an isometric view of an embodiment of a first box body of the battery apparatus in FIG. 20;

FIG. 22 is a partial structural view of a battery apparatus of some embodiments of the present application;

FIG. 23 is a sectional view taken along F-F in FIG. 22;

FIG. 24 is a partial enlarged view of part I in FIG. 23;

FIG. 25 is an isometric view of an embodiment of a battery cell in a battery apparatus of some embodiments of the present application; and

FIG. 26 is a structural view of a vehicle as an electrical device of some embodiments of the present application.

### Reference numerals in the Detailed Description

1000. vehicle; 100. battery apparatus; 200. controller; 300. motor;

110. battery cell assembly; 120. box; 121. first box body; 1211. frame; 12111. first side beam; 121111. first abutting surface; 12112. second side beam; 1212. structural beam; 12121. heat exchange flow channel; 12122. through hole; 12123. cavity; 12124. first interface; 12125. second interface; 1213. spacing beam; 1214. protective plate; 1215. buffer member; 1216. sealing member; 1217. locking member; 1218. flow collector member; 12181. flow collector unit; 121811. insertion portion; 121812. main body portion; 121813. tube portion; 1218121. flow collecting channel; 1218122. support rib; 12182. connecting portion; 121821. protrusion; 1219. connecting tube; 122. second box body; 130. thermal management component;

111. battery cell; 1111. pressure relief mechanism; 1112. electrode terminal;

X. first direction; Y. second direction; Z. height direction.

### DETAILED DESCRIPTION

The embodiments of the technical solutions of the present application will be described in detail below with reference to the accompanying drawings. The following embodiments are only used to more clearly illustrate the technical solutions of the present application, therefore only as examples, and cannot be used to limit the scope of protection of the present application.

Unless otherwise defined, all technical and scientific terms used herein have the same meanings as commonly understood by those skilled in the technical field to which the present application belongs. The terms used herein are intended only for the purpose of describing specific embodiments and are not intended to limit the present application. The terms “include” and “have” and any variations thereof in the specification and the claims of the present application and in the above Description of Drawings are intended to encompass non-exclusive inclusion.

In the description of the embodiments of the present application, the technical terms “first”, “second”, and the like, are used only to distinguish between different objects and are not to be understood as indicating or implying relative importance or implicitly specifying the number, particular order, or primary and secondary relationship of the technical features indicated. In the description of the embodiments of the present application, the meaning of “a plurality of” is two or more, unless otherwise explicitly and specifically defined.

Reference to “an embodiment” herein means that a particular feature, structure, or characteristic described with reference to an embodiment can be included in at least one embodiment of the present application. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

In the description of the embodiments of the present application, the term “and/or” is merely an association that describes the associated object, indicating that there can be three kinds of relationships, such as A and/or B, which can be denoted as: the existence of A alone, the existence of A and B at the same time, and the existence of B alone. Moreover, the character “/” herein generally indicates that the context objects are in an “or” relationship. In this disclosure, unless otherwise specified, phrases like “at least one of A, B, and C” and “at least one of A, B, or C” both mean only A, only B, only C, or any combination of A, B, and C.

In the description of the embodiments of the present application, the term “a plurality of” refers to two or more (including two), and similarly, “a plurality of groups” refers to two or more (including two) groups, and “a plurality of sheets” refers to two or more (including two) sheets.

In the description of the embodiments of the present application, the technical terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like which indicate the orientation or positional relationship are based on the orientation or positional relationship shown in the accompanying drawing, and are only for the convenience of describing the embodiments of the present application and simplifying the description, and do not indicate or imply that the device or element referred to must have a specific orientation, be constructed and operated in a specific orientation, and therefore cannot be construed as a restriction on the embodiments of the present application.

In the description of the embodiments of the present application, unless otherwise expressly specified and limited, the technical terms “mount”, “couple”, “connect”, “fix”, etc., should be understood in a broad sense, such as, a fixed connection, a detachable connection, or an integral connection; or a mechanical connection, or an electrical connection; or direct connection, indirect connection through an intermediate medium, or an internal communication of two elements, or interaction between two elements. For those of ordinary skill in the art, the specific meaning of the above terms in the embodiments of present application may be understood depending on the specific situation.

The bottom wall of the box of an existing battery apparatus is usually a large panel and is connected to the frame. The bottom wall is generally composed of a water-cooling plate with a complex flow channel inside. The welding process between the water-cooling plate and the frame is complicated, and the bottom wall formed by the water-cooling plate will increase the overall weight of the box. On the one hand, excessive box weight increases the material cost of the battery apparatus. On the other hand, excessive weight when used in new energy vehicles will reduce the cruising range of the vehicle.

In view of this, the present application provides a battery apparatus, in which a structural beam has a heat exchange flow channel inside, and a frame has a flow collecting channel. The heat exchange flow channels of two adjacent structural beams are connected through the flow collecting channel. During welding, compared with the conventional battery apparatus in which a water-cooling plate formed by a combination of a plurality of profile bottom plates is connected to the frame, the welding area can be reduced, the production efficiency can be improved, and the manufacturing cost can be reduced; at the same time, the heat exchange flow channels of two adjacent structural beams can be connected in series or in parallel as needed, so that the channels can be flexibly designed as needed to reduce the complexity of the structure. In addition, the plurality of structural beams are arranged at intervals along the second direction, which can also reduce the weight of the box and save the use of materials.

The battery apparatus mentioned in the embodiments of the present application may include one or more battery cell assemblies for providing voltage and capacity. The battery cell assembly may include a plurality of battery cells, and the plurality of battery cells are connected in series, in parallel, or in parallel-series connection through a bus component.

In some embodiments, a battery cell assembly is generally formed by arranging a plurality of battery cells.

As an example, the battery cell assembly may be a battery module, and the battery module is formed as an independent module by arranging and fixing a plurality of battery cells. As an example, the battery module may be formed by bundling the plurality of battery cells with cable ties.

In some embodiments, the battery apparatus may be a battery pack. The battery pack includes a box and one or more battery cell assemblies. The battery cell assembly is accommodated in the box.

As an example, the battery cell assembly may be a battery module, and the battery cell assembly may be accommodated in the box by fixing the battery module in the box.

As an example, the battery cell assembly may also be accommodated in the box by directly fixing a plurality of battery cells in the box.

As an example, the box may include a first box body and a second box body. The first box body and the second box body are snap-fitted together to accommodate the battery cell assembly.

As an example, the box may include a top cover, a frame, and a bottom plate. The top cover and the bottom plate are respectively connected to the frame, so that an enclosure space is formed inside the box to accommodate the battery cell assembly.

In some embodiments, the box may be a part of a vehicle chassis structure. For example, a part of the box may become at least a part of the floor of the vehicle, or a part of the box may become at least a part of a cross beam and a longitudinal beam of the vehicle.

The technical solutions described in the embodiments of the present application are all applicable to various electrical devices using battery apparatuses, such as electromobiles, vehicles, ships and spacecrafts. For example, the spacecrafts include airplanes, rockets, space shuttles, spaceships, etc.

In some embodiments, the battery cell may be a secondary battery. The secondary battery refers to a battery cell that can be charged to activate the active material and continue to be used after the battery cell is discharged.

The battery cell may be a lithium-ion battery, a sodium-ion battery, a sodium/lithium-ion battery, a lithium metal battery, a sodium metal battery, a lithium-sulfur battery, a magnesium-ion battery, a nickel-hydrogen battery, a nickel-cadmium battery, a lead storage battery, or the like, which is not limited in the embodiments of the present application.

The battery cell generally includes an electrode assembly. The electrode assembly includes a positive electrode, a negative electrode, and a separator provided between the positive electrode and the negative electrode. During charging and discharging of the battery cell, active ions such as lithium ions are intercalated and deintercalated back and forth between the positive electrode and the negative electrode. The separator is arranged between the positive electrode and the negative electrode, and can function to prevent a short circuit between the positive electrode and the negative electrode while enabling the active ions to pass through.

In some embodiments, the positive electrode may be a positive electrode plate, and the positive electrode plate may include a positive electrode current collector and a positive electrode active material arranged on at least one surface of the positive electrode current collector.

As an example, the positive electrode current collector has two surfaces opposite to each other in the thickness direction thereof, and the positive electrode active material is arranged on either or both of the two opposite surfaces of the positive electrode current collector.

As an example, the positive electrode current collector may be a metal foil, a conductive polymer material, a carbon material, or a composite current collector. For example, as the metal foil, pure metal, alloy and surface-treated metal can be used, including but not limited to stainless steel, copper, aluminum, nickel, titanium, silver, etc. The composite current collector may include a polymer material fiber layer and a metal layer. The composite current collector may be formed by forming a metal material, such as aluminum, aluminum alloy, nickel, nickel alloy, titanium, titanium alloy, silver, and silver alloy, on a polymer material substrate, such as a substrate of polypropylene, polyethylene terephthalate, polybutylene terephthalate, polystyrene, or polyethylene.

As an example, the positive electrode active material may include at least one of the following materials: a lithium-containing phosphate, a lithium transition metal oxide, and a respective modified compound thereof. However, the present application is not limited to these materials, and other conventional materials that can be used as positive electrode active materials for batteries may also be used. These positive electrode active materials may be used alone or in combination of two or more thereof. Examples of the lithium-containing phosphate may include, but are not limited to, at least one of lithium iron phosphate (e.g., LiFePO₄, also abbreviated as LFP), lithium iron phosphate-carbon composite, lithium manganese phosphate (e.g., LiMnPO₄), lithium manganese phosphate-carbon composite, lithium iron manganese phosphate, and lithium iron manganese phosphate-carbon composite. The examples of the lithium transition metal oxides may include, but are not limited to, at least one of lithium cobalt oxides (e.g., LiCoO₂), lithium nickel oxides (e.g., LiNiO₂), lithium-manganese oxides (e.g., LiMnO₂, LiMn₂O₄), lithium nickel cobalt oxides, lithium manganese cobalt oxides, lithium nickel manganese oxides (e.g., LiNi_{1/3}Co_{1/3}Mn_{1/3}O₂, also abbreviated as NCM₃₃₃; LiNi_{0.5}Co_{0.2}Mn_{0.3}O₂, also abbreviated as NCM₅₂₃; LiNi_{0.5}Co_{0.25}Mn_{0.25}O₂, also abbreviated as NCM₂₁₁; LiNi_{0.6}Co_{0.2}Mn_{0.2}O₂, also abbreviated as NCM₆₂₂; LiNi_{0.8}Co_{0.1}Mn_{0.1}O_{2,}, also abbreviated as NCM₈₁₁), lithium nickel cobalt aluminum oxides (e.g., LiNi_{0.8}Co_{0.15}Al_{0.05}O₂) and modified compounds thereof. The modified compound refers to a substance obtained by modifying the aforementioned substances by means of doping or coating.

In some embodiments, the positive electrode may be made of a foam metal. The foam metal may be foam nickel, foam copper, foam aluminum, foam alloy, foam carbon, or the like. When the foam metal is used as the positive electrode, the surface of the foam metal may not be provided with a positive electrode active material, and of course, may alternatively be provided with a positive electrode active material. As an example, the positive electrode active material is filled and/or deposited in the foam metal.

In some embodiments, the negative electrode may be a negative electrode plate, and the negative electrode plate may include a negative electrode current collector.

As an example, the negative electrode current collector may be a metal foil, a conductive polymer material, a carbon material, or a composite current collector. For example, as the metal foil, pure metal, alloy and surface-treated metal can be used, including but not limited to stainless steel, copper, aluminum, nickel, titanium, silver, etc. The composite current collector may include a polymer material fiber layer and a metal layer. The composite current collector may be formed by forming a metal material (copper, copper alloy, nickel, nickel alloy, titanium, titanium alloy, silver and silver alloy, etc.) on a polymer material substrate (such as substrate of polypropylene, polyethylene terephthalate, polybutylene terephthalate, polystyrene, polyethylene, etc.)

For example, the negative electrode plate may include a negative electrode current collector and a negative electrode active material arranged on at least one surface of the negative electrode current collector.

For example, the negative electrode current collector has two surfaces opposite to each other in its own thickness direction, and the negative electrode active material is arranged on either one or both of the two opposite surfaces of the negative electrode current collector.

As an example, the negative electrode active material may be a negative electrode active material commonly known in the art for use in battery cells. As an example, the negative electrode active material may include at least one of the following materials: artificial graphite, natural graphite, soft carbon, hard carbon, a silicon-based material, a tin-based material, lithium titanate, and the like. The silicon-based material may be selected from at least one of elemental silicon, a silicon-oxygen compound, a silicon-carbon composite, a silicon-nitrogen composite, and a silicon alloy. The tin-based material may be selected from at least one of elemental tin, tin-oxygen compound, and a tin alloy. However, the present application is not limited to these materials, and other conventional materials useful as negative electrode active materials for battery cells can also be used. One of these negative electrode active materials may be used alone, or two or more of these negative electrode active materials may be used in combination.

In some embodiments, a foam metal may be used as the negative electrode. The foam metal may be foam nickel, foam copper, foam aluminum, foam alloy, foam carbon, etc. When the foam metal is used as the negative electrode plate, the surface of the foam metal may not be provided with a negative electrode active material, and of course, may alternatively be provided with a negative electrode active material.

As an example, the negative electrode active material may be filled and/or deposited in the negative electrode current collector.

In some embodiments, the material of the positive electrode current collector may be aluminum, and the material of the negative electrode current collector may be copper.

In some embodiments, the electrode assembly further includes a separator provided between the positive electrode and the negative electrode.

In some embodiments, the separator is a separator film. The type of the separator film is not particularly limited in the present application, and any well-known separator film having good chemical stability and mechanical stability and of a porous structure can be selected.

As an example, the primary material of the separator film may be selected from at least one of glass fiber, non-woven fabric, polyethylene, polypropylene, polyvinylidene fluoride, or ceramic. The separator film may be a single-layer film, or may be a multi-layer composite film, which is not particularly limited. When the separator film is a multi-layer composite film, the materials of the layers can be the same or different, which is not particularly limited. The separator may be an independent component positioned between the positive electrode and the negative electrode, or may be attached to the surfaces of the positive electrode and the negative electrode. The surface of the separator film may also be coated with an inorganic particle coating, an organic particle coating, or an organic/inorganic composite coating.

In some embodiments, the separator is a solid electrolyte. The solid electrolyte is arranged between the positive electrode and the negative electrode, and functions to transport ions and isolate the positive electrode from the negative electrode.

In some embodiments, the battery cell further includes an electrolyte, and the electrolyte functions to conduct ions between the positive electrode and the negative electrode. The type of the electrolyte is not particularly limited in the present application and can be selected as needed. The electrolyte may be in a liquid state, a gel state, or a solid state.

A liquid electrolyte comprises an electrolyte salt and a solvent.

In some embodiments, the electrolyte salt may be selected from at least one of lithium hexafluorophosphate, lithium tetrafluoroborate, lithium perchlorate, lithium hexafluoroarsenate, lithium bis(fluorosulfonyl)imide, lithium bis(trifluoromethanesulfonyl)imide, lithium trifluoromethanesulfonate, lithium difluorophosphate, lithium difluoro(oxalato)borate, lithium bis(oxalato)borate, lithium difluoro bis(oxalato)phosphate, and lithium tetrafluoro(oxalato)phosphate.

In some embodiments, the solvent may be selected from at least one of ethylene carbonate, propylene carbonate, ethyl methyl carbonate, diethyl carbonate, dimethyl carbonate, dipropyl carbonate, methyl propyl carbonate, ethyl propyl carbonate, butylene carbonate, fluoroethylene carbonate, methyl formate, methyl acetate, ethyl acetate, propyl acetate, methyl propionate, ethyl propionate, propyl propionate, methyl butyrate, ethyl butyrate, 1,4-butyrolactone, sulfolane, dimethyl sulfolane, ethyl methyl sulfone and diethyl sulfone. The solvent may also be selected from ether solvents. The ether solvent may include one or more of ethylene glycol dimethyl ether, ethylene glycol diethyl ether, diethylene glycol dimethyl ether, triethylene glycol dimethyl ether, 1,3-dioxolane, tetrahydrofuran, methyltetrahydrofuran, diphenylether, or a crowned ether.

In some embodiments, the electrolyte solution further optionally includes an additive. For example, the additive may include a negative electrode membrane formation additive, a positive electrode membrane formation additive, or an additive capable of improving certain performances of the battery cell, such as an additive capable of improving over-charging/fast-charging performance of the battery cell, an additive capable of improving high temperature performance of the battery cell, or an additive capable of improving low temperature performance of the battery cell.

Specifically, the gel electrolyte includes polymer as a skeleton network, paired with an ionic liquid-lithium salt.

Specifically, the solid electrolyte includes a polymer solid electrolyte, an inorganic solid electrolyte, and a composite solid electrolyte.

As an example, the polymer of the polymer solid electrolyte may include polyether polyoxyethylene, polysiloxane, polycarbonate, polyacrylonitrile, polyvinylidene fluoride, polymethyl methacrylate, monoionic polymer, polyionic liquid, cellulose, etc.

As an example, the inorganic solid electrolyte may be one or more of an oxide solid electrolyte (crystalline perovskite, sodium superionic conductor, garnet, amorphous LiPON film), a sulfide solid electrolyte (a crystalline lithium superionic conductor lithium germanium phosphorus sulfide, argyrodite, amorphous sulfide, and a halide solid electrolyte, a nitride solid electrolyte, and a hydride solid electrolyte).

As an example, a composite solid electrolyte is formed by adding an inorganic solid electrolyte filler to a polymer solid electrolyte.

The electrode assembly may be of a wound structure, a laminated structure, or a mixed structure of a wound structure and a laminated structure.

In some embodiments, the electrode assembly is of a wound structure. The positive electrode plate and the negative electrode plate are wound into the wound structure.

In some embodiments, the electrode assembly is of a laminated structure.

As an example, a plurality of positive electrode plates and a plurality of negative electrode plates may be provided respectively, and the plurality of positive electrode plates and the plurality of negative electrode plates are stacked alternately.

As an example, a plurality of positive electrode plates may be provided, and the negative electrode plates are folded to form a plurality of stacked folded segments, with one positive electrode plate sandwiched between adjacent folded segments.

As an example, both the positive electrode plate and the negative electrode plate are folded to form a plurality of stacked folded segments.

As an example, a plurality of separators may be provided and arranged between any adjacent positive electrode plates or negative electrode plates.

As an example, the separators may be continuously arranged between any adjacent positive electrode plates or negative electrode plates by folding or winding.

In some embodiments, the shape of the electrode assembly may be cylindrical, flat, or polygonal prism-shaped.

In some embodiments, the electrode assembly is provided with tabs that can conduct current out of the electrode assembly. The tabs include a positive tab and a negative tab.

In some embodiments, the battery cell may include a shell. The shell may be a steel shell, an aluminum shell, a plastic shell (such as polypropylene), or a composite metal shell (such as a copper-aluminum composite shell). In some embodiments, the shell may be a sealed structure or a non-sealed structure.

As an example, the battery cell may be a cylindrical battery cell, a prismatic battery cell, or a battery cell of another shape. The prismatic battery cell includes a square-shell battery cell, a blade-shaped battery cell, and a polygonal prism battery (e.g., the polygonal prism battery may be a hexagonal prism battery), which is not particularly limited by the present application.

In some embodiments, the shell includes an end cover and a shell body. The shell body has an opening, and the end cover covers the opening. The shell body may be provided with one or more openings. One or more end covers may also be provided.

In some embodiments, the shell is provided with at least one electrode terminal, and the electrode terminal is electrically connected to the tab. The electrode terminal may be directly connected to the tab, or may alternatively be indirectly connected to the tab through a flow collector member. The electrode terminal may be arranged on the end cover, or may alternatively be arranged on the shell body.

In some embodiments, the shell is provided with a pressure relief mechanism. The pressure relief mechanism is used for discharging the internal gas out of the battery cell.

As an example, when the internal pressure or temperature of the battery cell reaches a predetermined threshold, the pressure relief mechanism is actuated to relieve the internal pressure or heat. When the internal pressure or temperature of the battery cell reaches the predetermined threshold, the pressure relief mechanism executes an action or a weak structure provided in the pressure relief mechanism is damaged, so as to form an opening or channel for relieving the internal pressure or heat. The design of the threshold varies depending on different design requirements. The threshold may depend on the material of one or more of a positive electrode plate, a negative electrode plate, an electrolyte, and a separator in the battery cell.

As an example, the pressure relief mechanism may be integrally formed with the shell.

As an example, the pressure relief mechanism may alternatively be provided separately from and connected to the shell.

The term “actuate” mentioned in the present application means that the pressure relief mechanism produces an action or is activated to a particular state, so that the internal pressure and heat of the battery cell can be relieved. The action produced by the pressure relief mechanism may include, but is not limited to: a component in the pressure relief mechanism moves to form an exhaust channel; at least a part in the pressure relief mechanism is ruptured, crushed, torn, opened, or the like. When the pressure relief mechanism is actuated, high-temperature and high-pressure substances inside the battery cell are discharged as emissions outwards from the actuated part. In this way, the pressure and heat of the battery cell can be relieved under controllable pressure or temperature, so as to prevent potential more serious accidents.

In some embodiments, when the shell is a non-sealed structure, the pressure relief mechanism can be provided as a through hole for discharging the gas inside the battery cell.

The emissions from the battery cell mentioned in the present application include, but are not limited to: an electrolyte, dissolved or split positive and negative electrode plates, fragments of a separator, high-temperature and high-pressure gas generated by reaction, flames, etc.

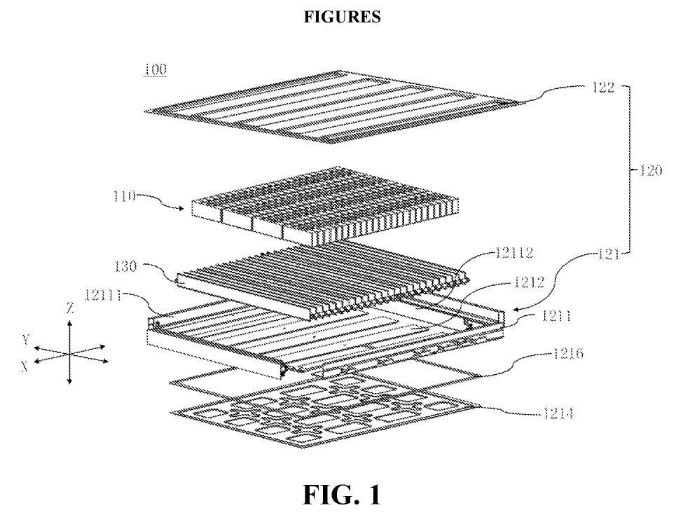

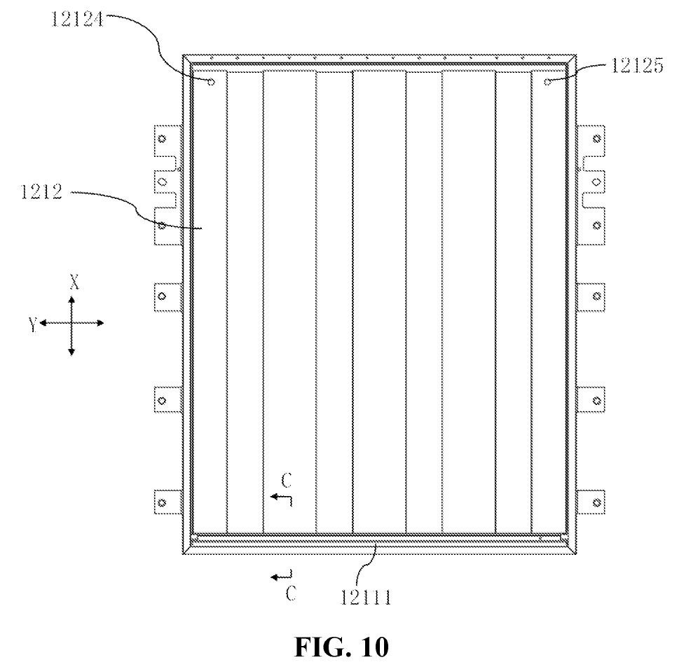

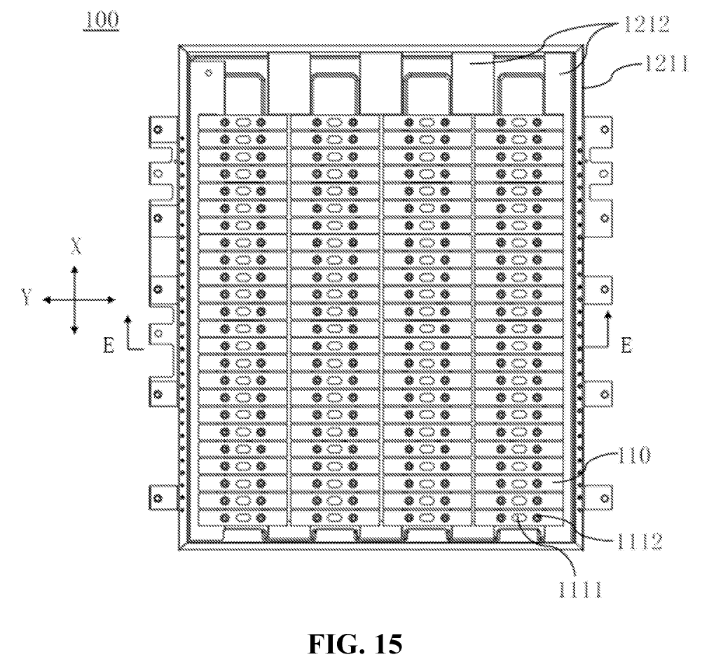

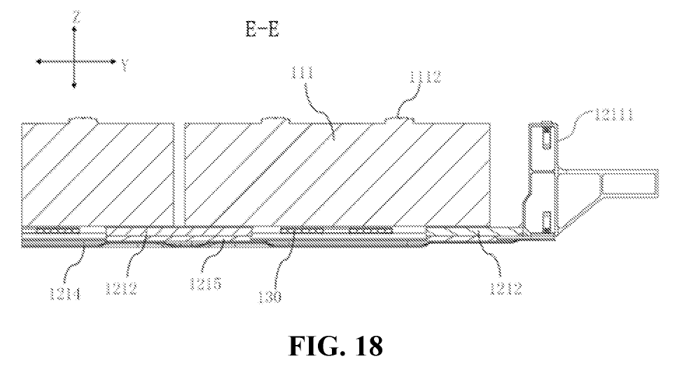

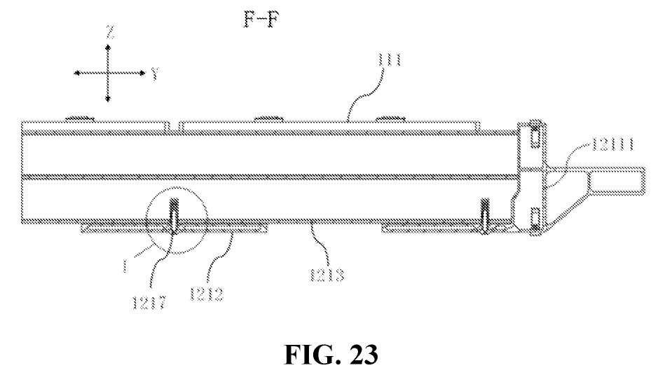

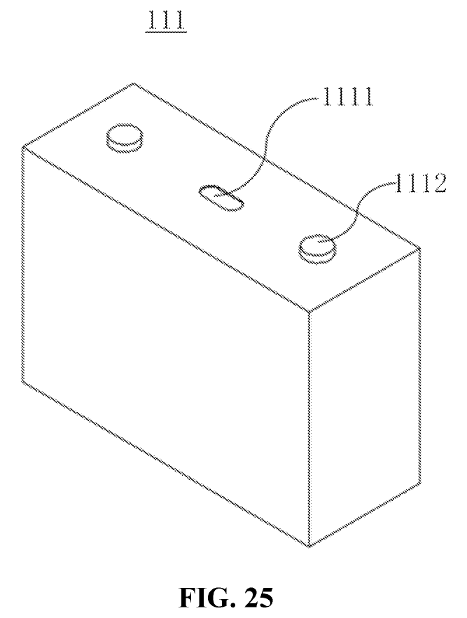

For the convenience of description of the following embodiments, referring to FIGS. 1 to 25, a battery apparatus 100 of some embodiments of the present application is taken as an example for description.

The battery apparatus 100 includes a battery cell assembly 110 and a box 120. Specifically, the battery cell assembly 110 includes a plurality of battery cells 111 arranged along a first direction X. The box 120 includes a first box body 121 and a second box body 122. The first box body 121 and the second box body 122 jointly define an accommodating space. The battery cell assembly 110 is located in the accommodating space. The first box body 121 has a flow collecting channel 1218121. The first box body 121 includes a frame 1211 and a plurality of structural beams 1212. The plurality of structural beams 1212 are arranged at intervals along a second direction Y. The plurality of structural beams 1212 are connected to the frame 1211. The structural beams 1212 each have a heat exchange flow channel 12121 inside. The heat exchange flow channels 12121 of two adjacent structural beams 1212 are in communication through the flow collecting channel 1218121. The first direction X intersects with the second direction Y. The plane where the first direction X and the second direction Y are located intersects with the height direction Z of the box 120.

The heat exchange flow channels 12121 in the plurality of structural beams 1212 can be connected in series and/or in parallel through the flow collecting channel 1218121.

The number of the heat exchange flow channels 12121 of the structural beams 1212 may be one or more. The structures of the heat exchange flow channels 12121 of the plurality of structural beams 1212 may be the same or different. By way of example, the heat exchange flow channels 12121 in some of the structural beams 1212 may extend in a generally U-shaped path, that is, the heat exchange medium may flow along the U-shaped path. The heat exchange flow channels 12121 in the structural beams 1212 may alternatively be straight channels or bent channels. Specifically, different structures of the heat exchange flow channels 12121 may be selected depending on the situation where the plurality of structural beams 1212 are connected in series and/or in parallel.

The battery cell 111 has an electrode terminal 1112. In an example, the electrode terminal 1112 is provided on the side of the battery cell 111 facing away from the second box body 122, the electrode terminal 1112 is located between two adjacent structural beams 1212, and the electrode terminal 1112 is spaced apart from the structural beams 1212 along the second direction Y; alternatively, the electrode terminal 1112 is provided on the side of the battery cell 111 facing the second box body 122. In another example, the electrode terminals 1112 are provided on both sides of the battery cell 111 respectively along the height direction Z of the box 120, where the electrode terminal 1112 on the side of the battery cell 111 facing away from the second box body 122 is located between two adjacent structural beams 1212 and is spaced apart from the structural beams 1212 along the second direction Y.

A heat exchange medium may be introduced into the heat exchange flow channel 12121 to adjust the temperature of the battery cell 111. The heat exchange medium may be air, water, or other organic or inorganic solvents, such as oil.

The plurality of structural beams 1212 are arranged at intervals along the second direction Y. When welding, compared with a conventional battery apparatus 100 in which a water-cooling plate formed by a combination of a plurality of profile bottom plates is connected to the frame 1211, the welding area can be reduced, the production efficiency is improved, and the manufacturing cost is reduced, the weight of the box is reduced, and the use of materials is saved. In addition, the structural beam 1212 has a heat exchange flow channel 12121 inside, the first box body 121 has a flow collecting channel 1218121, and the heat exchange flow channels 12121 of two adjacent structural beams 1212 are in communication through the flow collecting channel 1218121. The heat exchange flow channels 12121 of the two adjacent structural beams 1212 can be connected in series or in parallel as needed, so that the flow channels can be flexibly designed as needed, thereby reducing the complexity of the structure compared with the conventional heat exchange using a water-cooling plate for heat exchange with the battery cell.

In some embodiments, referring to FIGS. 1 to 4, the first box body 121 includes a flow collector member 1218, the frame 1211 includes two first side beams 12111 spaced apart along the first direction X, at least one end of the structural beam 1212 along the first direction X is connected with the flow collector member 1218, the structural beam 1212 is connected to the first side beam 12111 through the flow collector member 1218, the flow collector member 1218 includes at least one flow collector unit 12181, and the flow collector unit 12181 has a flow collecting channel 1218121 inside.

The number of the flow collector units 12181 may be one or more. The number of the flow collecting channels 1218121 of the flow collector units 12181 may be one or more.

The connection between two adjacent structural beams 1212 and the flow collector unit 12181 includes but is not limited to welding, adhesion, or integral molding.

The connection between the flow collector member 1218 and the first side beam 12111 includes but is not limited to welding or adhesion.

The structural beam 1212 is connected to the first side beam 12111 through the flow collector member 1218. During assembly, the flow collector member 1218 can be connected to the first side beam 12111 first, and then the structural beam 1212 can be connected to the flow collector member 1218 to achieve part-by-part assembly to facilitate the installation. In addition, the flow collector member 1218 is provided as a separate component to facilitate the production of the flow collecting channel 1218121.

In some embodiments, the structural beam 1212 is welded to the flow collector member 1218; and/or the frame 1211 is welded to the flow collector member 1218.

In an example, the structural beam 1212 and the frame 1211 are respectively welded to the flow collector member 1218 by means of friction welding or laser welding.

By directly welding the structural beam 1212 to the flow collector member 1218, the complex flow channel connection structure in the conventional profile bottom plate splicing is eliminated, the number of welds and the welding area are significantly reduced, the possibility of leakage caused by the large number of welds in the conventional profile splicing is reduced, and the sealing is improved. In addition, rigid connection is formed through welding of the structural beam 1212 to the frame 1211 via the flow collector member 1218, which improves the overall vibration and impact resistance of the box 120 and is beneficial for increasing the dominant frequency of the battery apparatus 100.

In some embodiments, the flow collector member 1218 further includes a connecting portion 12182, and both ends of the flow collector unit 12181 along the second direction Y are respectively connected with the connecting portions 12182. The end of the structural beam 1212 along the first direction X is welded to the connecting portion 12182; and/or the first side beam 12111 is welded to the connecting portion 12182.

In an example, the flow collector unit 12181 is welded to two adjacent structural beams 1212 respectively.

The connection between the connecting portion 12182 and the flow collector unit 12181 includes but is not limited to adhesion, welding, or integral molding.

In an example, the connecting portion 12182 is a strip-shaped structure extending along the second direction Y.

The connecting portion 12182 serves as an intermediate transition component between the structural beam 1212 and the frame 1211. The connecting portion 12182 is used as an intermediate transition component and is welded to the structural beam 1212 and/or the first side beam 12111 to facilitate the manufacture of the first box body 121.

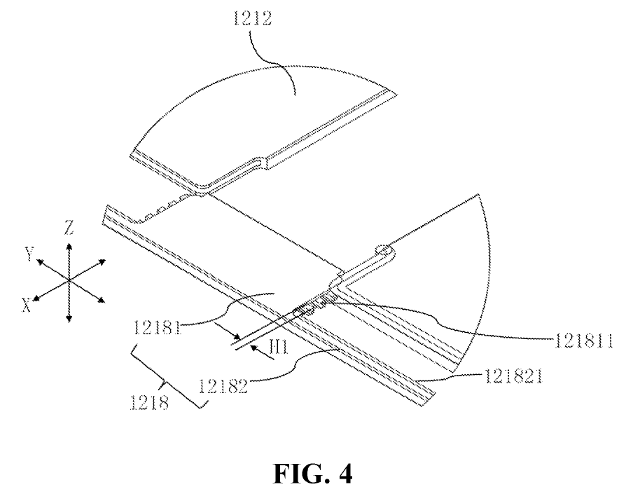

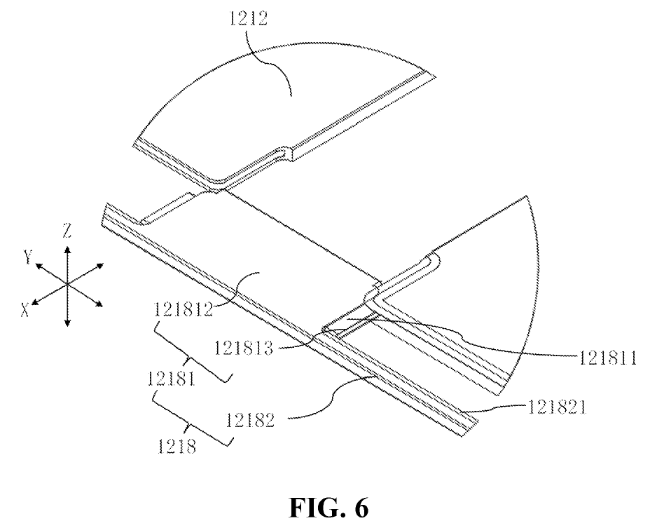

In some embodiments, referring to FIGS. 4 and 6, the flow collector member 1218 further includes an insertion portion 121811, and both ends of the flow collector unit 12181 along the second direction Y are respectively provided with the insertion portions 121811. The insertion portion 121811 at one end of the flow collector unit 12181 along the second direction Y is a first insertion portion, and the insertion portion 121811 at the other end of the flow collector unit 12181 along the second direction Y is a second insertion portion. The first insertion portion is inserted into the heat exchange flow channel 12121 of one of the two adjacent structural beams 1212, and the second insertion portion is inserted into the heat exchange flow channel 12121 of the other one of the two adjacent structural beams 1212.

In some examples, the insertion portion 121811 may be a hollow annular structure or a solid insertion strip.

The insertion portion 121811 and the flow collector unit 12181 may be integrally formed, or may be fixed by means of welding, screw connection, or the like.

The insertion portion 121811 inserted into the heat exchange flow channel 12121 forms an internal support structure. The welding of the flow collector unit 12181 and the structural beam 1212 can be achieved by friction welding. Under the pressure of friction welding, the insertion portion 121811 can reduce the possibility of plastic deformation or collapse of the thin-walled heat exchange flow channel 12121 due to squeezing, so that better sealing is provided during the friction welding process and the possibility of the heat exchange flow channel 12121 being crushed can be reduced. After welding, the heat exchange flow channel 12121 and the flow collecting channel 1218121 are in smoother communication. In addition, since the structural beam 1212 is subjected to the weight from the battery cell 111, part of the stress can be dispersed through the insertion portion 121811 to reduce the stress at the welding point between the flow collector unit 12181 and the structural beam 1212, thereby reducing the possibility of the structural beam 1212 breaking due to excessive force at the weld position, and improving the reliability of the structural beam 1212 at the connection position of the flow collector member 1218.

In some embodiments, referring to FIG. 4, the insertion depth of the insertion portion 121811 into the heat exchange flow channel 12121 along the second direction Y is H1, and the value of H1 ranges from 5 mm to 10 mm.

The insertion depth in a range of 5 to 10 mm enables the insertion portion 121811 to provide sufficient supporting force during the friction welding process to disperse the stress during the welding process, while avoiding excessive waste of materials to save the manufacturing cost. In addition, when the structural beam 1212 is subjected to the weight from the battery cell 111 or the battery apparatus 100 is in a vibrating environment, limiting H1 within the above numerical range can disperse the stress, reduce the possibility of the structural beam 1212 breaking due to excessive force at the weld position, and improve the reliability of the structural beam 1212 at the connection position of the flow collector member 1218.

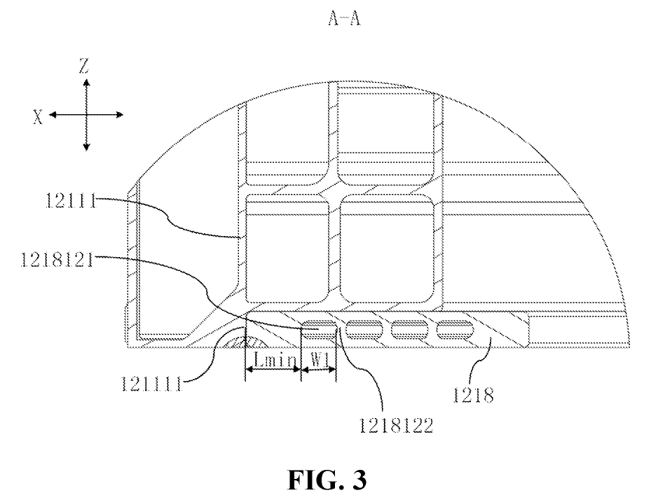

In some embodiments, referring to FIG. 3, there are a plurality of flow collecting channels 1218121, and the plurality of flow collecting channels 1218121 are arranged at intervals along the second direction Y. A support rib 1218122 is formed between two adjacent flow collecting channels 1218121, and the support rib 1218122 extends from both ends of the flow collecting channels 1218121 along the second direction Y. The part of the support rib 1218122 extending from the end of the flow collecting channel 1218121 along the second direction Y is configured as an insertion portion 121811.

There may be one or more support ribs 1218122 at the same end of the flow collecting channel 1218121 along the second direction Y.

As there are a plurality of support ribs 1218122 at the same end of the flow collecting channel 1218121 along the second direction Y, the stress during friction welding can be better dispersed to reduce the possibility of the flow collecting channel 1218121 being crushed and thus blocked.

The provision of the support ribs 1218122 can reduce the possibility of the flow collecting channel 1218121 being crushed during the friction welding process, so that the flow collecting channel 1218121 and the heat exchange flow channel 12121 can be in smooth communication after welding, thereby improving the welding quality.

In some embodiments, referring to FIG. 3, the dimension of the flow collecting channel 1218121 along the first direction X is W1, and the value of W1 ranges from 4 mm to 10 mm.

As such, when the flow collector unit 12181 is friction welded to the frame 1211, the possibility of the flow collecting channel 1218121 being crushed due to excessive friction welding pressure can be reduced, and the welding quality can be improved, so that the flow collecting channel 1218121 and the heat exchange flow channel 12121 can be in smooth communication after welding.

In some embodiments, referring to FIG. 6, the flow collector unit 12181 includes a main body portion 121812 and a tube portion 121813, the main body portion 121812 has an accommodating cavity inside, the accommodating cavity runs through both ends of the main body portion 121812 along the second direction Y, the tube portion 121813 is located in the accommodating cavity, both ends of the tube portion 121813 extend from both ends of the main body portion 121812 along the second direction Y, the part of the tube portion 121813 extending from the main body portion 121812 is configured as an insertion portion 121811, the tube portion 121813 has a flow collecting channel 1218121 inside, and the flow collecting channel 1218121 runs through both ends of the tube portion 121813.

In this embodiment, the main body portion 121812 and the tube portion 121813 may both be made of the same non-metallic material or metallic material, or alternatively, the two may be made of different materials.

During friction welding, the tube portion 121813 can provide support for the heat exchange flow channel 12121 to reduce the possibility of the flow collecting channel 1218121 being crushed.

In some embodiments, the strength of the tube portion 121813 is greater than that of the main body portion 121812.

The tube portion 121813 and the main body portion 121812 may be made of two different materials, metal material or non-metal material. For example, the main body portion 121812 is made of metal, and the tube portion 121813 is made of non-metallic material or metal material. Specifically, the main body portion 121812 may be made of aluminum alloy, and the tube portion 121813 may be made of a flat steel tube. The tube portion 121813 and the accommodating cavity are fixed by interference fit.

As the strength of the tube portion 121813 is greater than that of the main body portion 121812, the possibility of the flow collecting channel 1218121 being crushed can be reduced during friction welding. At the same time, due to the greater strength of the tube portion 121813, the flow area of the flow collecting channel 1218121 can be made larger to reduce the flow resistance of the heat exchange medium.

In some embodiments, referring to FIG. 4, the flow collector member 1218 further includes a connecting portion 12182, both ends of the flow collector unit 12181 along the second direction Y are respectively connected with the connecting portions 12182, and the connecting portions 12182 are respectively connected to the end of the structural beam 1212 and the frame 1211.

The flow collector unit 12181 and the connecting portion 12182 may be integrally formed or fixed by means of welding.

The connecting portion 12182 serves as an intermediate transition component between the structural beam 1212 and the frame 1211. After the connecting portion 12182 is connected to the frame 1211, the connecting portion 12182 can be connected to the structural beam 1212. The assembly operation can be facilitated through section-by-section assembly.

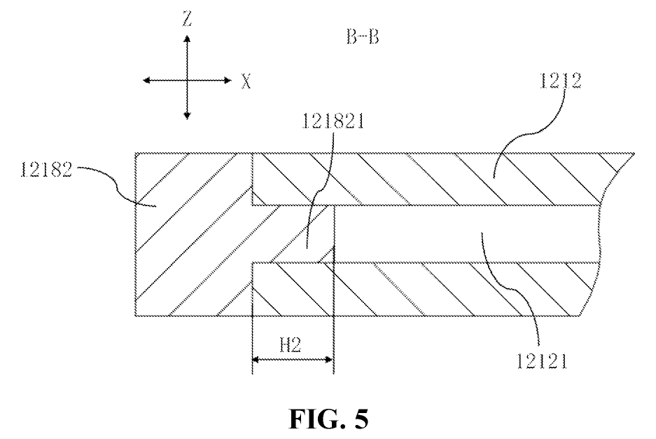

In some embodiments, referring to FIGS. 4 and 5, the side of the connecting portion 12182 facing the structural beam 1212 is provided with a protrusion 121821, and the protrusion 121821 is inserted into the heat exchange flow channel 12121.

The shape of the cross section of the protrusion 121821 may be, but is not limited to, a square, a U-shape, a hemispherical shape, etc., and the cross section of the protrusion 121821 is perpendicular to the second direction Y.

The protrusion 121821 inserted into the heat exchange flow channel 12121 forms a support structure. The welding of the flow collector member 1218 and the structural beam 1212 can be achieved by friction welding. Under the pressure of friction welding, the protrusion 121821 can reduce the possibility of plastic deformation or collapse of the heat exchange flow channel 12121 due to squeezing, so that better sealing is provided during the friction welding process and the possibility of the heat exchange flow channel 12121 being crushed can be reduced. After welding, the heat exchange flow channel 12121 and the flow collecting channel 1218121 are in smoother communication. In addition, since the structural beam 1212 is subjected to the weight from the battery cell 111, part of the stress can be dispersed through the protrusion 121821 to reduce the stress at the welding point between the flow collector unit 12181 and the structural beam 1212, thereby reducing the possibility of the structural beam 1212 breaking due to excessive force at the weld position, and improving the reliability of the structural beam 1212 at the connection position of the flow collector member 1218.

In some embodiments, referring to FIG. 5, the dimension of the protrusion 121821 along the first direction X is H2, and the value of H2 ranges from 5 mm to 10 mm.

By setting H2 within the above range, the protrusion 121821 is enabled to provide sufficient supporting force during the friction welding process to disperse the stress during the welding process, while avoiding excessive waste of materials to save the manufacturing cost. In addition, when the structural beam 1212 is subjected to the weight from the battery cell 111 or the battery apparatus 100 is in a vibrating environment, limiting H2 within the above numerical range can disperse the stress, reduce the possibility of the structural beam 1212 breaking due to excessive force at the weld position, and improve the reliability of the structural beam 1212 at the connection position of the flow collector member 1218.

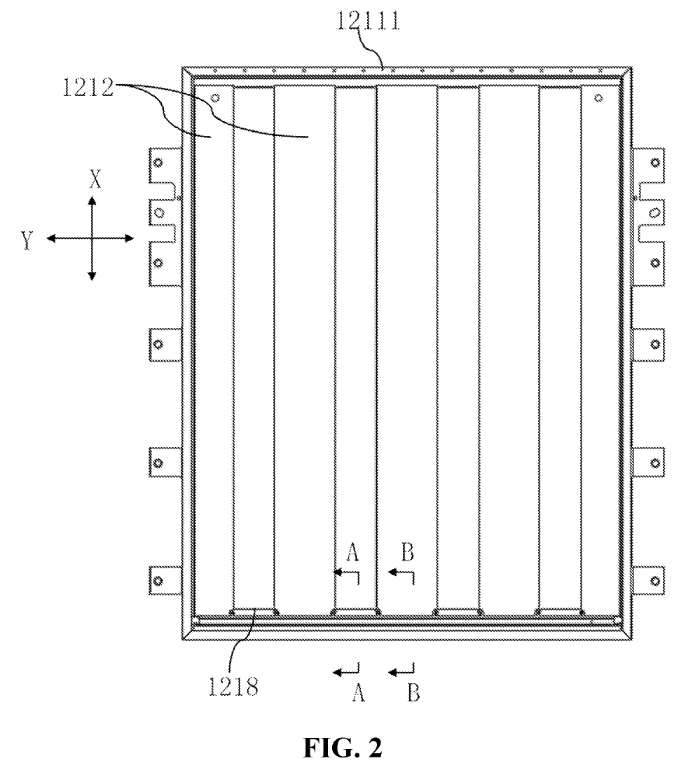

In some embodiments, referring to FIG. 2, there are a plurality of flow collector units 12181, two adjacent flow collector units 12181 are spaced apart along the second direction Y, and the two adjacent flow collector units 12181 are connected via the connecting portion 12182.

Specifically, the number of the flow collector units 12181 is N, and the number of the structural beams 1212 may be N+1, where N is an integer greater than 2.

In contrast to the method of connecting each flow collector unit 12181 to the frame 1211 individually, the plurality of flow collector units 12181 are integrated into an integral part. In this way, it is only needed to connect the integral part to the frame 1211, and then connect the flow collector units 12181 to the structural beam 1212 one by one, which saves the time of installing the plurality of flow collector units 12181 to the frame 1211 individually and improves assembly efficiency. At the same time, it can reduce the installation deviation caused by installing the flow collector units 12181 individually.

In some embodiments, referring to FIG. 3, the frame 1211 includes a first side beam 12111, which is connected to the flow collector member 1218 and has a first abutting surface 121111 that abuts against the flow collector member 1218 along the first direction X. Along the first direction X, the minimum distance between the heat exchange flow channel 12121 and the first abutting surface 121111 is Lmin, and the value of Lmin ranges from 5 mm to 15 mm.

Optionally, the first side beam 12111 and the flow collector member 1218 may be connected by welding, specifically by friction welding.

When the flow collector member 1218 and the frame 1211 are friction welded, setting Lmin within the above range can reduce the possibility of the heat exchange flow channel 12121 being crushed due to friction welding, thereby improving the welding quality.

In some embodiments, the frame 1211 includes two first side beams 12111 spaced apart along the first direction X, the structural beam 1212 is directly welded to the first side beams 12111, and at least one of the first side beams 12111 has a flow collecting channel 1218121 inside.

In an example, the first side beam 12111 has a mold cavity, and the mold cavity of the first side beam 12111 serves as the flow collecting channel 1218121.

Directly connecting the structural beam 1212 to the first side beam 12111 can reduce the welding area, reduce the manufacturing cost, and improve the production efficiency of the battery apparatus 100, while reducing the complexity of the structure and facilitating manufacturing.

In some embodiments, the heat exchange flow channels 12121 inside the plurality of structural beams 1212 are communicated in series or in parallel to form a heat exchange flow path, the heat exchange flow path has a first interface 12124 and a second interface 12125, one of the first interface 12124 and the second interface 12125 is configured to allow a heat exchange medium to flow in, and the other one of the first interface 12124 and the second interface 12125 is configured to allow a heat exchange medium to flow out.

The first interface 12124 may be arranged at one of the two outermost structural beams 1212 along the second direction Y, and the second interface 12125 may be arranged at the other one of the two outermost structural beams 1212 along the second direction Y. The first interface 12124 and the second interface 12125 may be located at the end of the structural beam 1212 away from the flow collector member 1218.

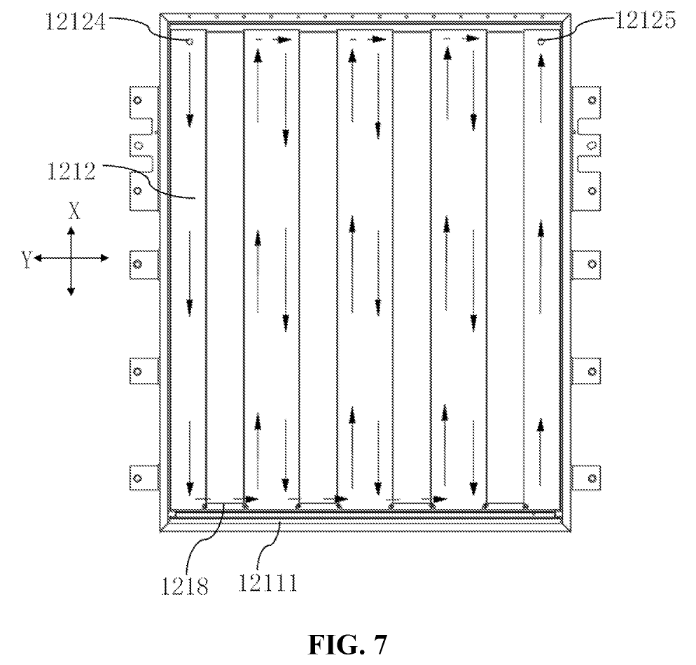

FIG. 7 illustrates a structural view in which the heat exchange flow channels 12121 inside the plurality of structural beams 1212 are connected in series. The direction of the arrow in FIG. 7 is the direction in which the heat exchange medium flows in the heat exchange flow path. Along the second direction Y, the heat exchange medium flows from the outermost structural beam 1212 through the middle structural beam 1212 and finally flows out from another outermost structural beam 1212.

The heat exchange flow channels 12121 inside the plurality of structural beams 1212 are communicated in series, which can prolong the heat exchange time and achieve more sufficient heat transfer at an unchanged flow rate, and has the characteristics of low resistance and small pressure drop. The heat exchange flow channels 12121 inside the plurality of structural beams 1212 are communicated in parallel, which can reduce pressure loss, and the synchronous cooling of the parallel branches makes the inlet temperatures of various branches of the heat exchange flow path consistent, which is beneficial for reducing the temperature difference between different areas of the battery cells 111 and making the temperatures of different battery cells 111 more uniform.

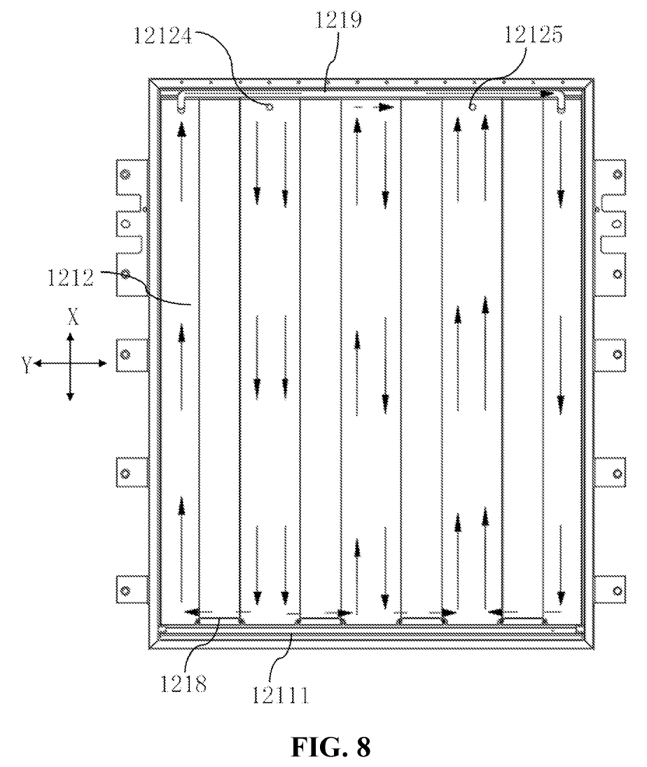

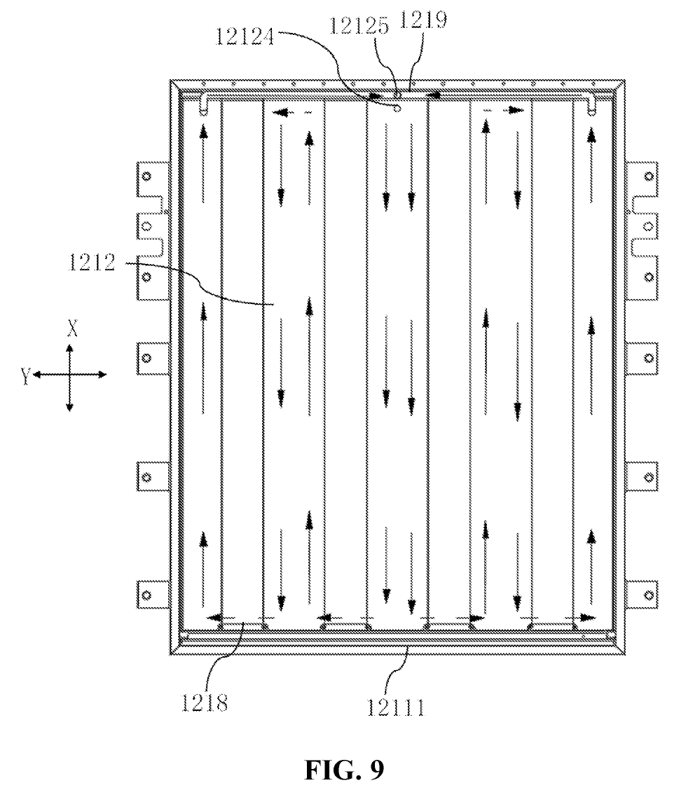

In some embodiments, referring to FIGS. 8 and 9, there are more than three structural beams 1212, the heat exchange flow channels 12121 inside the plurality of structural beams 1212 are communicated in series and in parallel to form a heat exchange flow path, the heat exchange flow path has a first interface 12124 and a second interface 12125, one of the first interface 12124 and the second interface 12125 is configured to allow a heat exchange medium to flow in, and the other one of the first interface 12124 and the second interface 12125 is configured to allow a heat exchange medium to flow out.

Taking three structural beams 1212 as an example, the heat exchange flow channels 12121 of two structural beams 1212 are communicated in series and then connected in parallel with the heat exchange flow channel 12121 of the other structural beam 1212 to form a mixed flow path having both series and parallel connections.

Taking five structural beams 1212 as an example, the two outermost structural beams 1212 along the second direction Y are in communication, specifically through a connecting tube 1219, and the other two structural beams 1212 adjacent to the two outermost structural beams 1212 are provided with a first interface 12124 and a second interface 12125, and the first interface 12124 and the second interface 12125 are respectively located at the ends of the structural beams 1212 facing away from the flow collector member 1218, and the flow direction of the heat exchange medium is as shown by the arrow in the figure.

The heat exchange flow channels 12121 inside the plurality of structural beams 1212 are communicated in series and in parallel, which on the one hand, in the case of communication in series, can prolong the heat exchange time at an unchanged flow rate, achieve more sufficient heat transfer, and has the characteristics of low resistance and small pressure drop; on the other hand, in the case of communication in parallel, can reduce the pressure loss, and the synchronous cooling of the parallel branches makes the inlet temperatures of various branches of the heat exchange flow path consistent, which is beneficial for reducing the temperature difference between different areas of the battery cells 111.

In some embodiments, referring to FIGS. 8 and 9, the first box body 121 further includes a connecting tube 1219, one of the two outermost structural beams 1212 along the second direction Y is the first structural beam, and the other one of the two outermost structural beams 1212 along the second direction Y is the second structural beam, and the heat exchange flow channel 12121 of the first structural beam is in communication with the heat exchange flow channel 12121 of the second structural beam through the connecting tube 1219.

The heat exchange flow channel 12121 of one can be communicated in series with the heat exchange flow channel 12121 of the second through the connecting tube 1219. The connecting tube 1219 can be arranged at the end of the structural beam 1212 facing away from the flow collector member 1218, which can reduce the possibility of interference after the battery cell 111 is installed.

As such, by providing the connecting tube 1219, the plurality of structural beams 1212 can realize the layout of complex flow paths in series and parallel, which can reduce the complexity of the structure compared with the conventional complex flow paths using water-cooling plates.

In some embodiments, referring to FIGS. 8 and 9, along the second direction Y, one of the structural beam 1212 between the two outermost structural beams 1212 and the connecting tube 1219 is provided with a first interface 12124, and the other one of the structural beam 1212 between the two outermost structural beams 1212 and the connecting tube 1219 is provided with a second interface 12125.

There may be one or more structural beams 1212 between the two outermost structural beams 1212. For example, when there are two structural beams 1212 between the two outermost structural beams 1212, one of the structural beams 1212 between the two outermost structural beams 1212 and the connecting tube 1219 is provided with a second interface 12125.

Thus, the first interface 12124 and the second interface 12125 can be provided in the structural beam 1212 and the connecting tube 1219, and a variety of different heat exchange flow paths can be realized, which can be adjusted according to the operating temperature of the battery apparatus 100, thereby achieving better heat exchange effect.

In some embodiments, referring to FIG. 9, the frame 1211 includes two first side beams 12111 spaced apart along the second direction Y, one of the plurality of structural beams 1212 is located in the middle of the two first side beams 12111, and the structural beam 1212 located in the middle of the two first side beams 12111 is provided with a first interface 12124.

The middle of the two first side beams 12111 refers to a position at an equal distance from the two first side beams 12111 along the second direction Y.

When the battery apparatus 100 is operating, the temperature of the battery cell 111 corresponding to the structural beam 1212 in the middle area is more concentrated and higher. Through the above structure, the heat exchange medium can generally enter from the structural beam 1212 in the middle area, flow through the outermost structural beam 1212, and then flow out from the structural beam 1212 in the middle area, so that the heat exchange is more uniform, the overall temperature gradient is reduced, and the overall heat dissipation is improved.

For the convenience of description of the following embodiments, referring to FIGS. 1 and 12 to 25, a battery apparatus 100 of some embodiments of the present application is taken as an example for the description.

The battery apparatus 100 includes a battery cell assembly 110 and a box 120. The battery cell assembly 110 includes a plurality of battery cells 111 arranged along a first direction X. The box 120 includes a first box body 121 and a second box body 122, which cover each other and jointly define an accommodating space. The battery cell assembly 110 is located in the accommodating space. The first box body 121 includes a frame 1211 and a plurality of structural beams 1212. The structural beams 1212 are located at the bottom of the frame 1211 and connected to the frame 1211. The plurality of structural beams 1212 are arranged at intervals along the second direction Y. The first direction X intersects with the second direction Y, and the plane where the first direction X and the second direction Y are located intersects with the height direction Z of the box 120.

The structural beam 1212 may be a hollow beam or a solid beam. The material of the structural beam 1212 may be, but is not limited to, aluminum, aluminum alloy, steel or other metals or non-metals, which may be specifically determined according to the actual application scenario of the battery apparatus 100. For example, when the battery apparatus 100 is used in a new energy vehicle, the material of the structural beam 1212 may be aluminum alloy.

There may be one or more battery cell assemblies 110, and each battery cell assembly 110 includes a plurality of battery cells 111. The battery cell 111 in the battery cell assembly 110 may be, but is not limited to, a square battery cell or a blade battery cell.

For example, the number of the battery cell assembly 110 is one, and the battery cell 111 is a blade battery cell. Each blade battery cell may be connected to a plurality of structural beams 1212, and each blade battery cell may be supported by the plurality of structural beams 1212.

The connection between the structural beam 1212 and the frame 1211 includes but is not limited to welding, riveting or screw connection.

The same battery cell 111 may be supported by one, two or more structural beams 1212. For example, a structural beam 1212 may be arranged between two electrode terminals 1112 of the same battery cell 111.

In an optional example, the second box body 122 has a protrusion on the side facing the battery cell 111, and the protrusion extends along the first direction X. The second box body 122 may be formed with the protrusion by stamping, that is, a groove is formed on the side of the protrusion facing away from the battery cell 111.

By arranging a plurality of structural beams 1212 at intervals, the weight of the box 120 can be reduced to save material costs, compared with a conventional box in which a large bottom plate or a water-cooling plate is used as the bottom wall.

In some embodiments, the battery cell 111 is connected to the structural beams 1212.

The battery cell 111 can be fixed to the structural beam 1212 and the second box body 122 respectively by adhesion, a pressure strip, etc.

For example, a pressure strip is provided on the side of the battery cell 111 facing the second box body 122, and the pressure strip is connected to the first box body 121 through screws, and the pressure strip is used to constrain the battery cell 111.

The battery cell 111 is connected to the structural beam 1212 to increase the dominant frequency of the battery apparatus 100. In the case of vibration or expansion, the possibility of electrical connection failure of components inside the battery apparatus 100 can be reduced, thereby improving the reliability of operation of the battery apparatus 100.

In some embodiments, the battery cell 111 is adhered to the structural beam 1212.

The battery cell 111 is adhered to the structural beam 1212, which can increase the dominant frequency of the battery apparatus 100, so as to reduce the possibility of electrical connection failure of components inside the battery apparatus 100 in situations with vibration and impact or when the battery cell 111 expands, thereby improving the reliability of operation of the battery apparatus 100; and compared with the conventional large-area glue filling at the bottom of the box, the amount of structural glue used can be saved, which is beneficial for reducing the weight of the battery apparatus 100 and reducing the manufacturing cost.

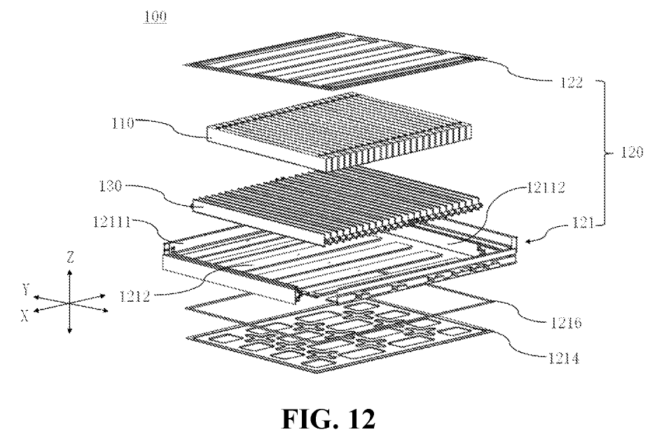

In some embodiments, referring to FIGS. 12 to 14, the same battery cell 111 is adhered to a plurality of structural beams 1212.

In an example, the battery cell 111 is a blade battery cell, and each blade battery cell is adhered to all the structural beams 1212. The number of the structural beams 1212 may be at least two, specifically two. The two structural beams 1212 are connected to the two first side beams 12111 of the frame 1211 spaced apart along the second direction Y in one-to-one correspondence, specifically by means of, without limitation, welding or integral molding.

By having a plurality of structural beams 1212 jointly support the same battery cell 111, the stress generated by expansion during battery charging and discharging or external vibration impact force can be evenly dispersed to the plurality of structural beams 1212, thereby reducing excessive deformation of the structural beams 1212 caused by local stress concentration. The integrated structure formed by adhesion of a plurality of structural beams 1212 can significantly increase the dominant frequency of the battery apparatus 100, and suppress the displacement of the battery cell 111 or fatigue failure of electrical connection components such as tabs caused by vibration, which is beneficial for improving the stability of the battery apparatus 100.

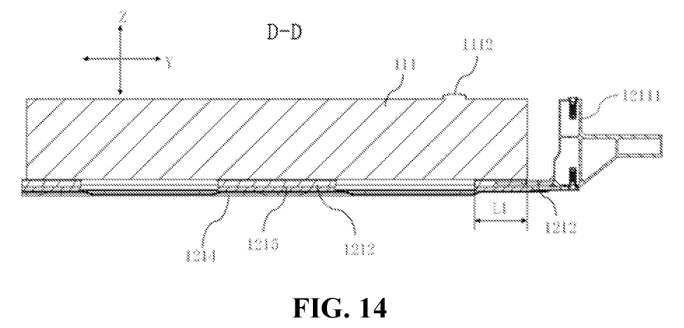

In some embodiments, referring to FIG. 14, along the height direction Z of the box 120, the orthographic projection area of each structural beam 1212 on the same battery cell 111 is S1, and the area of the side of the battery cell 111 facing the structural beam 1212 is S2. The structural beam 1212 is a solid beam, and the value of S2/S1 ranges from 1.4 to 5; or alternatively, the structural beam 1212 is a hollow beam, and the value of S2/S1 ranges from 1.4 to 2.5.

The value range of S2/S1 is limited to the above range, which can prevent the weight of the box 120 from being too heavy. On the other hand, provided that the structural beam 1212 has sufficient support strength, the dominant frequency of the battery apparatus 100 will not be too low, so as to reduce the possibility of electrical connection failure of components inside the battery apparatus 100 in an environment with vibration and impact or when the battery cell 111 expands, thereby improving the reliability of operation of the battery apparatus 100.

In some embodiments, when the structural beam 1212 is a solid beam, the value of S2/S1 ranges from 1.6 to 3.3; and when the structural beam 1212 is a hollow beam, the value of S2/S1 ranges from 1.6 to 2.

The value range of S2/S1 is limited to the above range, which can further take into account the requirements of both weight and support strength, so that the dominant frequency of the battery apparatus 100 will not be too low.

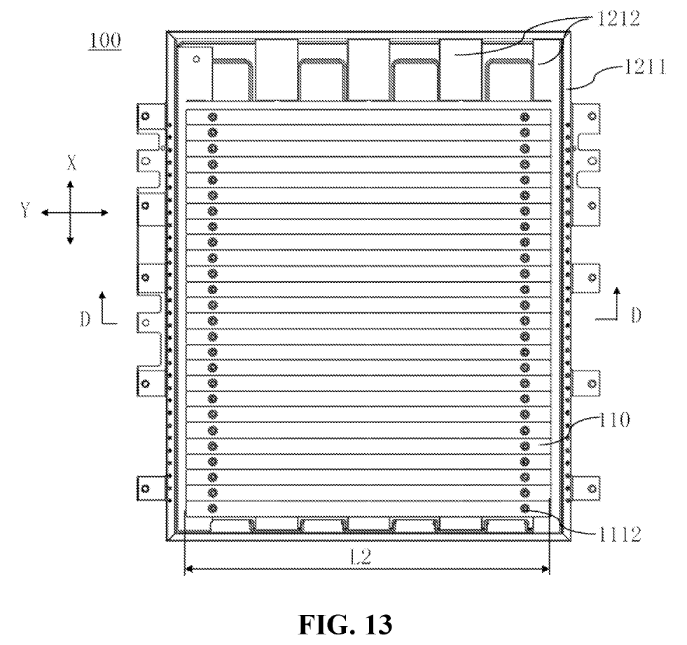

In some embodiments, referring to FIGS. 13 and 14, along the height direction Z of the box 120, the dimension of the orthographic projection of each structural beam 1212 on the same battery cell 111 along the second direction Y is L1, and the dimension of the battery cell 111 along the second direction Y is L2.

The structural beam 1212 is a solid beam, and the value of L1/L2 ranges from 0.2 to 0.7; or alternatively, the structural beam 1212 is a hollow beam, and the value of L1/L2 ranges from 0.4 to 0.7.

In an example, regardless of whether the structural beam 1212 is a solid beam or a hollow beam, L1/L2=0.5, and along the second direction Y, of two adjacent structural beams 1212, the dimension of the part of each structural beam 1212 adhered to the same battery cell 111 accounts for 1/2 of the dimension of the structural beam 1212.

The value range of L1/L2 is limited to the above range, which can not only ensure that the battery cell 111 has a sufficient contact area with the structural beam 1212 to disperse the stress, but also reduce the increase in weight of the box 120 due to excessive dimension.

In some embodiments, when the structural beam 1212 is a solid beam, the value of L1/L2 ranges from 0.3 to 0.6; and when the structural beam 1212 is a hollow beam, the value of L1/L2 ranges from 0.5 to 0.6.

The value range of L1/L2 is limited to the above range, and the value range is further optimized, which can not only ensure that the battery cell 111 has a sufficient contact area with the structural beam 1212 to disperse the stress, but also reduce the increase in weight of the box 120 due to excessive dimension.

In some embodiments, referring to FIGS. 14 to 18, the same battery cell 111 is adhered to two adjacent structural beams 1212.

A part of each structural beam 1212 is adhered to the battery cell 111 by means of structural adhesive, so that the two adjacent structural beams 1212 are adhered to the same battery cell 111.

Therefore, compared with the case where the battery cell 111 is supported by one structural beam 1212, the force to be borne by a structural beam 1212 can be reduced to reduce the deformation of the structural beam 1212, so that in an environment with vibration and impact or when the battery cell 111 expands, the possibility of electrical connection failure of components inside the battery apparatus 100 is reduced, thereby improving the reliability of operation of the battery apparatus 100.

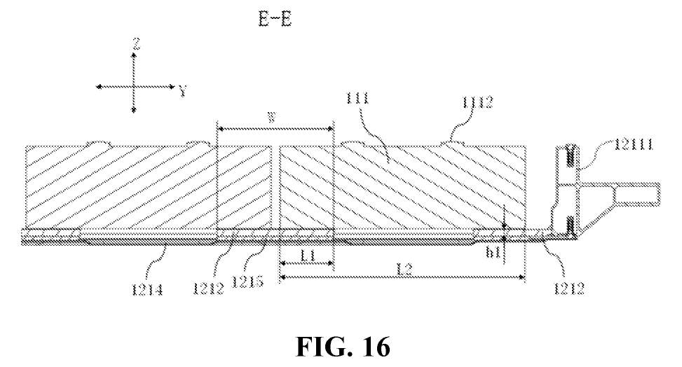

In some embodiments, referring to FIGS. 16 to 18, there are a plurality of battery cell assemblies 110, and the plurality of battery cell assemblies 110 are arranged along the second direction Y, and two adjacent battery cell assemblies 110 are adhered to the same structural beam 1212.

The same structural beam 1212 can support two adjacent battery cell assemblies 110, so that a plurality of battery cell assemblies 110 are adhered to a plurality of structural beams 1212 through structural adhesive to form an integrated structure, which is beneficial for improving the dominant frequency of the battery apparatus 100 and reducing the possibility of electrical connection failure of components inside the battery apparatus 100 in an environment with vibration and impact or when the battery cell 111 expands, thereby improving the reliability of operation of the battery apparatus 100. In addition, two adjacent battery cell assemblies 110 are supported by one structural beam 1212, which can save the number of structural beams 1212 used, and is beneficial for reducing the weight of the box 120 of the battery apparatus 100.

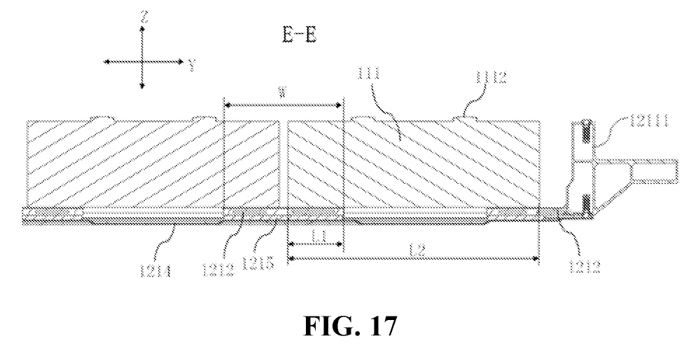

In some embodiments, referring to FIGS. 16 and 17, along the height direction Z of the box 120, the orthographic projection area of a single structural beam 1212 on the same battery cell 111 is S1, and the area of the side of the battery cell 111 facing the structural beam 1212 is S2. The structural beam 1212 is a solid beam, and the value of S2/S1 ranges from 2.8 to 10; or alternatively, the structural beam 1212 is a hollow beam, and the value of S2/S1 ranges from 2.8 to 5.

When the structural beam 1212 is a solid beam, the value of S2/S1 may be 2.8, 3, 4, 5, 6, 7, 8, 9, 10 or any value in the range defined by any two of the above values.

When the structural beam 1212 is a hollow beam, the value of S2/S1 may be but is not limited to 2.8, 3, 3.5, 4, 4.5, 5 or any value in the range defined by any two of the above values.

When the structural beam 1212 is a hollow beam, the cavity inside the structural beam 1212 can be used as a weight-reducing cavity, and can also be used as a heat exchange flow channel 12121.

The value range of S2/S1 is limited to the above range, which can prevent the weight of the box 120 from being too heavy. On the other hand, provided that the structural beam 1212 has sufficient support strength, the dominant frequency of the battery apparatus 100 will not be too low, so as to reduce the possibility of electrical connection failure of components inside the battery apparatus 100 in an environment with vibration and impact or when the battery cell 111 expands, thereby improving the reliability of operation of the battery apparatus 100.

In some embodiments, when the structural beam 1212 is a solid beam, the value of S2/S1 ranges from 3.3 to 6.6; and when the structural beam 1212 is a hollow beam, the value of S2/S1 ranges from 3.3 to 4.

The value range of S2/S1 is limited to the above range, which can further take into account the requirements of both weight and support strength, so that the dominant frequency of the battery apparatus 100 will not be too low.

In some embodiments, along the height direction Z of the box 120, the dimension of the orthographic projection of each structural beam 1212 on the same battery cell 111 along the second direction Y is L1, and the dimension of the battery cell 111 along the second direction Y is L2. The structural beam 1212 is a solid beam, and the value of L1/L2 ranges from 0.1 to 0.35; or alternatively, the structural beam 1212 is a hollow beam, and the value of L1/L2 ranges from 0.2 to 0.35.

The value range of L1/L2 is limited to the above range, which can not only ensure that the battery cell 111 has a sufficient contact area with the structural beam 1212 to disperse the stress, but also reduce the increase in weight of the box 120 due to excessive dimension.

In some embodiments, when the structural beam 1212 is a solid beam, the value of L1/L2 ranges from 0.15 to 0.3; and when the structural beam 1212 is a hollow beam, the value of L1/L2 ranges from 0.25 to 0.3.

The value range of L1/L2 is limited to the above range, and the value range is further optimized, which can not only ensure that the battery cell 111 has a sufficient contact area with the structural beam 1212 to disperse the stress, but also reduce the increase in weight of the box 120 due to excessive dimension.

In some embodiments, the dimension of the structural beam 1212 along the second direction Y is W. The structural beam 1212 is a solid beam, and the value of W ranges from 20 mm to 700 mm; or alternatively, the structural beam 1212 is a hollow beam, and the value of W ranges from 40 mm to 700 mm.

For solid beams or hollow beams, a smaller lower limit can meet the demand for support in low-load scenarios while reducing material consumption. The upper limit of 700 mm provides redundancy for high bearing demand. A wide beam can enhance vibration resistance. If the blade battery is long and heavy, it can be supported by a wider structural beam 1212 to maintain the stability of the overall structure of the battery apparatus 100.

The thermal management component 130 includes a heat exchange plate.

In an example, in order to reduce the weight of the box 120, the thermal management component 130 may be a lightweight plastic heat exchange plate. There may be one or more thermal management components 130 between two adjacent structural beams 1212, which is not specifically limited.

As such, the temperature of each battery cell can be adjusted by the thermal management component 130 so that each battery cell 111 can fully exert its own performance during operation, thereby reducing the impact of excessively high or low temperature on the performance of the battery cell 111.

In some embodiments, referring to FIGS. 16 to 18, the structural beam 1212 is a flat beam, and the thickness direction of the structural beam 1212 is the same as the height direction Z of the box 120.

For the same total height of the box 120, the flat beam will not occupy too much space at the bottom of the box 120, so as to accommodate a battery cell 111 with a larger volume. For the same width of the structural beam 1212, the flat beam can reduce the weight of the box 120 and save more materials.

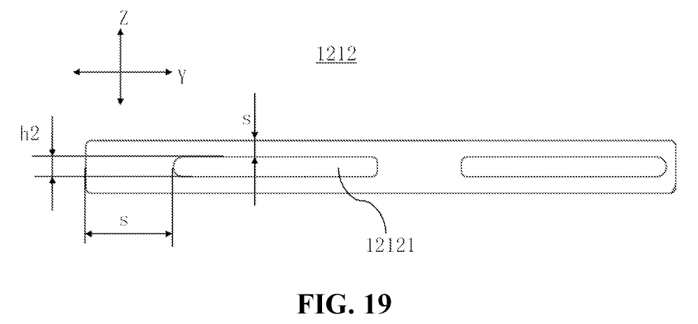

In some embodiments, referring to FIG. 16, the structural beam 1212 is a solid beam. Along the height direction Z of the box 120, the dimension of the structural beam 1212 is h1, where the value range of h1 may be, but is not limited to, 3 mm to 8 mm. In some embodiments, referring to FIGS. 17 and 19, the structural beam 1212 is a hollow beam, and along the height direction Z of the box 120, the dimension of the cavity of the structural beam 1212 is h2, and the wall thickness of the structural beam 1212 is s. The value range of h2 may be, but is not limited to, 4.4 mm to 8 mm, and the value range of s may be, but i snot limited to, 1.8 mm to 3 mm.

When the structural beam 1212 is a hollow beam, the wall thickness of the structural beam 1212 includes the thickness of the wall of the cavity.

When the structural beam 1212 is a hollow beam, the wall thickness of the structural beam 1212 along the height direction Z of the box 120 and the wall thickness of the structural beam 1212 along the second direction Y may be equal or unequal.

As such, for the same total height of the box 120, it will not occupy too much space at the bottom of the box 120, so as to accommodate a battery cell 111 with a larger volume. For the same width of the structural beam 1212, it can reduce the weight of the box 120 and save more materials.

In some embodiments, referring to FIGS. 17 and 19, a heat exchange flow channel 12121 is provided inside the structural beam 1212.

Optionally, the heat exchange flow channel 12121 extends along the first direction X, and the heat exchange flow channel 12121 may be a bent channel or a straight channel.

There may be one or more heat exchange flow channels 12121 in the structural beam 1212. When there are a plurality of heat exchange flow channels 12121 in the structural beam 1212, the plurality of heat exchange flow channels 12121 may be communicated in series or in parallel. The heat exchange flow channels 12121 of two adjacent structural beams 1212 may be communicated in series or in parallel.

A heat exchange flow channel 12121 is provided inside the structural beam 1212, which can further reduce the weight of the box 120 on the one hand, and on the other hand, by passing a heat exchange medium into the heat exchange flow channel 12121, the operating temperature of the battery cell 111 can be adjusted, so that the battery apparatus 100 can operate within a suitable temperature range to give full play to the performance of the battery apparatus 100. In addition, a heat exchange flow channel 12121 is provided in the structural beam 1212, which can reduce the manufacturing difficulty compared with the conventional battery apparatus using a water-cooling plate.

In some embodiments, referring to FIG. 12, the battery apparatus 100 further includes a thermal management component 130. The thermal management component 130 is arranged between two adjacent battery cells 111 along the first direction X. The thermal management component 130 has a heat exchange channel inside.

The thermal management component 130 may be a heat exchange plate. When there are more than three battery cells 111 in the battery cell assembly 110, two adjacent thermal management components 130 may be communicated in series or in parallel.

In an example, the heat exchange channel of the thermal management component 130 and the heat exchange flow channel 12121 of the structural beam 1212 may be communicated in parallel or in series, specifically through pipelines, or may not be communicated.

As such, the temperature of each battery cell 111 can be adjusted by the thermal management component 130 so that each battery cell 111 can fully exert its own performance during operation, thereby reducing the impact of excessively high or low temperature on the performance of the battery cell 111. In other embodiments, the thermal management component 130 may not be provided between two adjacent battery cells 111, and the cavity of the structural beam 1212 may simply be used as a heat exchange flow channel.

In some embodiments, referring to FIGS. 1 and 12, the frame 1211 includes two first side beams 12111 spaced apart along the second direction Y, and the two outermost structural beams 1212 along the second direction Y are first structural beams, which are connected to the first side beams 12111.

The frame 1211 further includes second side beams 12112 arranged at intervals along the first direction X, and at least some of the structural beams 1212 may be connected to the second side beams 12112, specifically by welding.

The connection between the first structural beam and the first side beam 12111 includes but is not limited to welding, screw connection, or riveting.

The first side beam 12111 serves as a lateral boundary support of the frame 1211, which can increase the overall rigidity of the first box body 121 and reduce the risk of local deformation due to uneven force. In an environment with vibration and impact or when the battery cell 111 expands, the possibility of electrical connection failure of components inside the battery apparatus 100 can be reduced, thereby improving the reliability of the battery apparatus 100.

In some embodiments, the first structural beam and the first side beam 12111 are integrally formed.

The first structural beam and the first side beam 12111 can be manufactured into an integral structure by extrusion molding or welding.

Thus, the overall rigidity of the box 120 can be further improved. Meanwhile, compared with the case where the first structural beam and the second side beam 12112 are connected by other means, such as fasteners, the connection method can be simplified and the assembly efficiency can be improved.

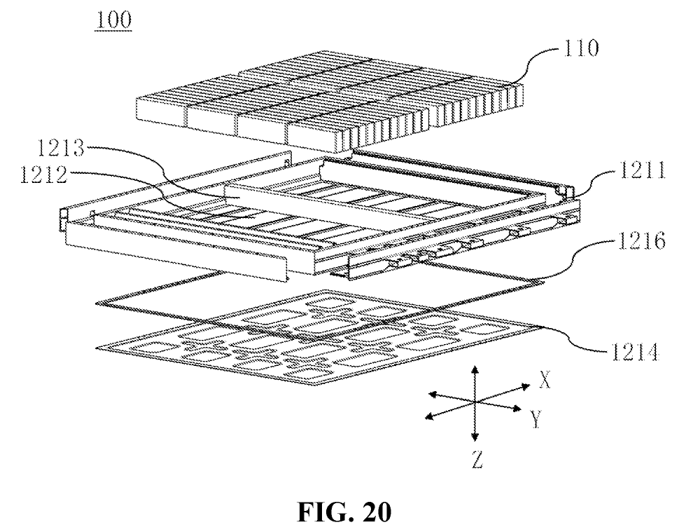

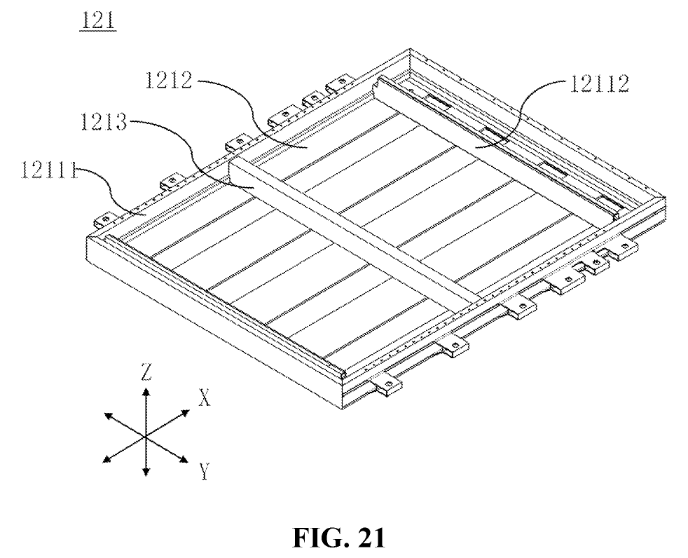

In some embodiments, referring to FIGS. 20 and 21, the first box body 121 further includes a spacing beam 1213, the length direction of the spacing beam 1213 is the same as the second direction Y, and battery cell assemblies 110 are respectively provided on both sides of the spacing beam 1213 along the first direction X, and at least one of the structural beam 1212 and the frame 1211 is connected to the spacing beam 1213.

The spacing beam 1213 may be a solid beam or a hollow beam.

The connection between at least one of the structural beam 1212 and the frame 1211 and the spacing beam 1213 may be, but is not limited to, welding, screw connection, or riveting.

In an example, two ends of the spacing beam 1213 may be welded to different first side beams 12111.

The length direction of the spacing beam 1213 may be substantially perpendicular to the length direction of the structural beam 1212.

The provision of the spacing beam 1213 can further improve the bending strength of the plurality of structural beams 1212, thereby increasing the dominant frequency of the battery apparatus 100 and reducing the possibility of electrical connection failure of components inside the battery apparatus 100 when the battery apparatus 100 is in an environment with vibration and impact or when the battery cell 111 expands, thereby improving the reliability of operation of the battery apparatus 100.

In some embodiments, referring to FIGS. 21 to 23, the structural beam 1212 has a through hole 12122, and the through hole 12122 runs through both sides of the structural beam 1212 along the height direction Z of the box 120. The first box body 121 further includes a locking member 1217, and one end of the locking member 1217 passes through the through hole 12122 and is connected to the spacing beam 1213.

The structural beam 1212 may be a solid beam or a hollow beam.

Thus, the fixing of the plurality of structural beams 1212 and the spacing beam 1213 can be achieved to increase the bearing capacity of the structural beams 1212, which is beneficial for improving the dominant frequency of the battery apparatus 100.

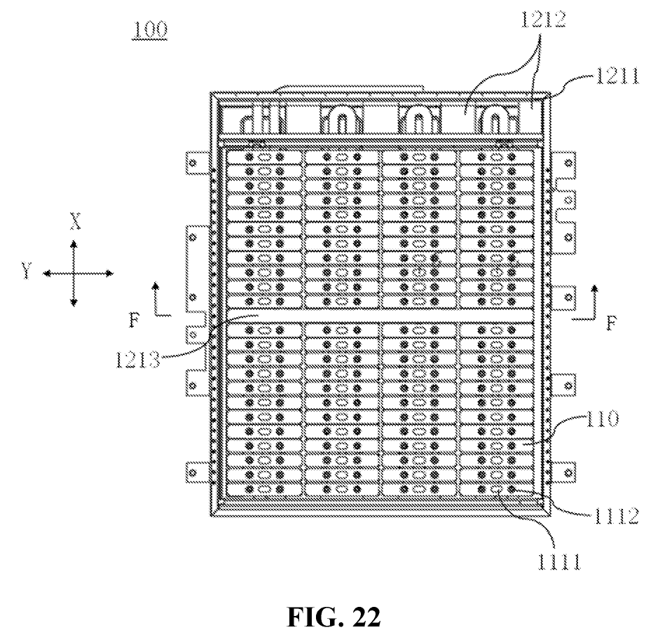

In some embodiments, referring to FIGS. 22 to 24, the structural beam 1212 has a cavity 12123 inside, and along the height direction Z of the box 120, a side wall on the side of the cavity 12123 along the second direction Y is run through by a through hole 12122.

There may be one or more cavities 12123. The cavity 12123 can be used as a weight-reducing cavity or as a heat exchange flow channel 12121. For example, when the cavity 12123 is used as a heat exchange flow channel, the cavity 12123 extends along the length direction of the structural beam 1212.

Provided that the dominant frequency of the battery apparatus 100 is ensured, the structural beam 1212 is provided to have a structure with a cavity 12123, which can reduce the weight of the box 120 and save material costs. In addition, the cavity 12123 can also be used as a heat exchange channel to adjust the temperature of the battery cell 111 during operation.

In some embodiments, referring to FIGS. 22 to 24, there are a plurality of cavities 12123, and the plurality of cavities 12123 are arranged at intervals along the second direction Y, and a sidewall is formed between at least some of the two adjacent cavities 12123.

Thus, the weight of the box 120 can be further reduced.

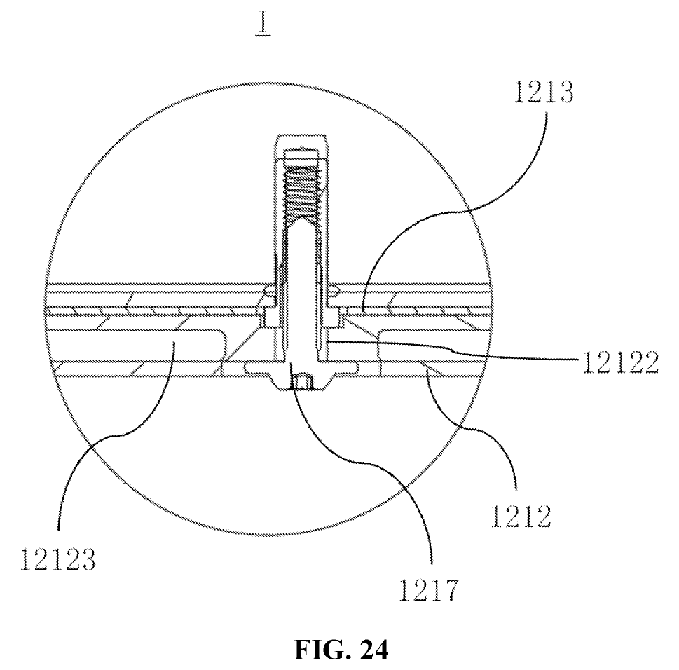

In some embodiments, referring to FIG. 24, along the height direction Z of the box 120, the dimension of the orthographic projection of the locking member 1217 on the structural beam 1212 along the second direction Y is less than or equal to the dimension of the side wall along the second direction Y.

The dimension of the orthographic projection of the locking member 1217 on the structural beam 1212 along the second direction Y is D1, and the dimension of the side wall along the second direction Y is D2, where D1 is less than or equal to D2, so that the area of the side wall is greater than or equal to the area of the compression surface of the locking member 1217 on the structural beam 1212, so as to reduce the stress of the locking member 1217 on the structural beam 1212, to reduce the possibility of the cavity 12123 being crushed due to the excessive pressure of the locking member 1217, and meet the support stiffness and lightweight requirements of the structural beam 1212.

In some embodiments, referring to FIGS. 1 and 12, an electrode terminal 1112 is provided on the side of the battery cell 111 facing the second box body 122.

This facilitates electrical connection between the electrode terminal 1112 of the battery cell 111 and the electrode terminal 1112 of another battery cell 111. In other examples, the electrode terminal 1112 is provided on the side of the battery cell 111 facing away from the second box body 122.

In some embodiments, a pressure relief mechanism 1111 is provided on the side of the battery cell 111 facing the second box body 122, and the pressure relief mechanism 1111 is used to be actuated to release emissions when the battery cell 111 thermally runs away and the internal pressure of the battery cell 111 reaches a set value.

The pressure relief mechanism 1111 can effectively reduce the risk of pressure accumulation inside the battery cell 111 and improve the safety of the battery apparatus 100.

In some embodiments, referring to FIGS. 1 and 12, the first box body 121 further includes a protective plate 1214. The protective plate 1214 is located on the side of the first box body 121 facing away from the second box body 122 and is connected to the first box body 121.

The connection between the protective plate 1214 and the first box body 121 includes screw connection, riveting or welding, etc.

For example, the protective plate 1214 can be locked to the frame 1211 by screws.

The provision of the protective plate 1214 can protect the side of the first box body 121 facing away from the second box body 122, especially when the battery apparatus 100 is used in a new energy vehicle, in which case it can absorb external impacts and collisions.

In some embodiments, referring to FIGS. 16 to 18, the first box body 121 further includes a buffer member 1215, and the buffer member 1215 is arranged between the protective plate 1214 and the structural beam 1212.

The buffer member 1215 may be made of foam, polyurethane or fiber-reinforced thermoplastic material, etc.

The buffer member 1215 is arranged between the protective plate 1214 and the first box body 121 to buffer external impacts, thereby improving protection for the battery cell 111 and thus improving the reliability of operation of the battery cell 111.

In some embodiments, referring to FIGS. 1 and 12, the first box body 121 further includes a sealing member 1216, which is arranged around the accommodating space, and the sealing member 1216 is sandwiched between the protective plate 1214 and the frame 1211.

The sealing member 1216 may be, but is not limited to, a sealing gasket, a sealing ring, or a sealant, etc.

The sealing member 1216 can prevent external dust, water, etc. from entering the battery apparatus 100, so as to protect the components in the battery apparatus 100.

In some embodiments, referring to FIGS. 1 and 12, the first box body 121 is located below the second box body 122. The battery cell 111 is connected to the structural beam 1212 and the second box body 122 respectively, and the electrode terminal 1112 of the battery cell 111 is inverted in the box 120. Compared with the structure in which the electrode terminal 1112 is upright in the box 120, the space utilization rate of the box 120 can be improved.

In some embodiments, the structural beam 1212 is a solid beam, and the structural beam 1212 includes a main body portion and a reinforcement strip. The main body portion has an accommodating cavity extending along the length direction of the structural beam 1212, and the accommodating cavity runs through at least one end of the main body portion. The reinforcement strip is located in the accommodating cavity and fits against the inner wall of the accommodating cavity. The strength of the reinforcement strip is greater than that of the main body portion. The shape of the cross section of the reinforcement strip may be, but is not limited to, circular, square, or elliptical, etc., which can improve the overall rigidity of the structural beam 1212 and reduce the deformation of the structural beam 1212 when bearing load.

In some embodiments, the dimension of the battery cell 111 along the second direction Y may range, without limitation, from 200 mm to 2000 mm.

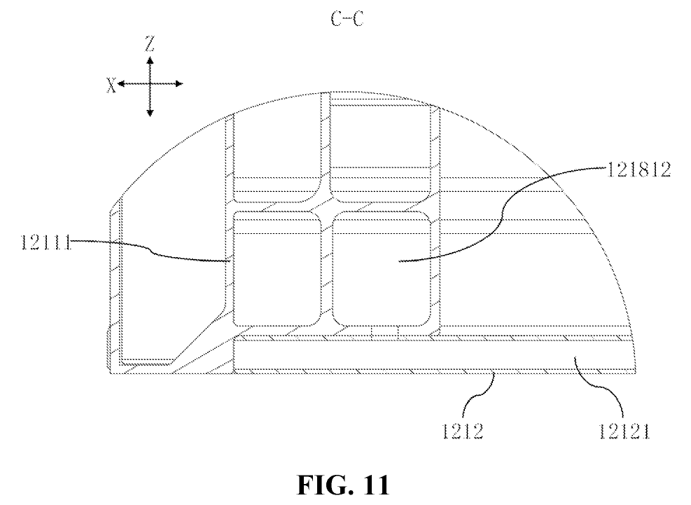

In some embodiments, referring to FIGS. 1 to 10, the first box body 121 further includes a flow collector member 1218, the structural beam 1212 has a heat exchange flow channel 12121 inside, and the flow collector member 1218 is located at one end of the structural beam 1212 along the first direction X. The specific structure of the flow collector member 1218 and the method of connection of the flow collector member 1218 with the frame 1211 and the structural beam 1212 respectively may be the structures listed in the above embodiments, which will not be described in detail again here. In other embodiments, referring to FIG. 11, the structural beam 1212 is directly connected to the first side beam 12111. The specific structure can be seen from the above embodiment and will not be described in detail again here.

The battery cell 111 may be a square-shell battery cell, or a blade battery cell, etc, which is not specifically limited here.

For ease of description, the following embodiments are illustrated with an electrical apparatus in some embodiments of the present application as an example.

The electrical apparatus includes the battery apparatus 100 of the above embodiments, the battery apparatus 100 being used to supply electrical energy to the electrical apparatus.

The electrical apparatus includes, but is not limited to, a battery cart, an electric tool, a vehicle 1000, a ship, and a spacecraft, etc. For example, the spacecraft includes an airplane, a rocket, a space shuttle, and a spacecraft, etc.

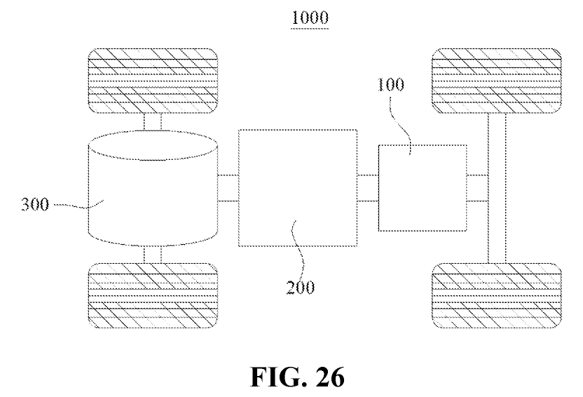

Refer to FIG. 26, which is a schematic structural view of a vehicle 1000 provided by some embodiments of the present application. The vehicle 1000 may be a fuel vehicle, a gas vehicle, or a new energy vehicle. The new energy vehicle may be an all-electric vehicle, a hybrid electric vehicle, an extended-range electric vehicle, or the like. A battery apparatus 100 is arranged in the vehicle 1000. The battery apparatus 100 may be arranged at the bottom, or head, or tail of the vehicle 1000. The battery apparatus 100 may be configured to supply power to the vehicle 1000. For example, the battery apparatus 100 may be used as an operating power source of the vehicle 1000. The vehicle 1000 may further include a controller 200 and a motor 300, where the controller 200 is used to control the battery apparatus 100 to supply power to the motor 300, for example, for the operating power demand when the vehicle 1000 is starting, navigating and traveling.

Since the electrical apparatus includes all the technical features of the battery apparatus 100 in the above embodiments, it has the same effects as those described above and will not be described in detail again here.

In a first optional embodiment of the battery apparatus 100, referring to FIGS. 1 to 5, 8 and 9, the battery apparatus 100 includes a battery cell assembly 110 and a box 120. Specifically, the battery cell assembly 110 includes a plurality of battery cells 111 arranged along the first direction X. The first box body 121 and the second box body 122 are included and jointly define an accommodating space, and the battery cell assembly 110 is located in the accommodating space. The first box body 121 includes a frame 1211 and a plurality of structural beams 1212, and the plurality of structural beams 1212 are arranged at intervals along the second direction Y. The first box body 121 includes a flow collector member 1218, and the frame 1211 includes two first side beams 12111 spaced apart along the first direction X. One end of the structural beam 1212 along the first direction X is connected with the flow collector member 1218, through which the structural beam 1212 is welded to the first side beam 12111. The flow collector member 1218 includes a connecting portion 12182 and at least one flow collector unit 12181, and the flow collector unit 12181 has a flow collecting channel 1218121 inside. The structural beam 1212 has a heat exchange flow channel 12121 inside, and the heat exchange flow channels 12121 of two adjacent structural beams 1212 are communicated through a flow collecting channel 1218121. The first direction X intersects with the second direction Y, and the plane in which the first direction X and the second direction Y are located intersects with the height direction Z of the box 120. Both ends of the flow collector unit 12181 along the second direction Y are respectively connected with connecting portions 12182, and the connecting portions 12182 are respectively welded to the end of the structural beam 1212 and the frame 1211. The flow collector unit 12181 is welded to two adjacent structural beams 1212 respectively. Both ends of the flow collector unit 12181 along the second direction Y are respectively provided with the insertion portions 121811. The insertion portion 121811 at one end of the flow collector unit 12181 along the second direction Y is a first insertion portion, and the insertion portion 121811 at the other end of the flow collector unit 12181 along the second direction is a second insertion portion. The first insertion portion is inserted into the heat exchange flow channel 12121 of one of the two adjacent structural beams 1212, and the second insertion portion is inserted into the heat exchange flow channel 12121 of the other one of the two adjacent structural beams 1212. The insertion depth of the insertion portion 121811 into the heat exchange flow channel 12121 along the second direction Y is H1, and the value of H1 ranges from 5 mm to 10 mm. There are a plurality of flow collecting channels 1218121, and the plurality of flow collecting channels 1218121 are arranged at intervals along the second direction Y. A support rib 1218122 is formed between two adjacent flow collecting channels 1218121, and the support rib 1218122 extends from both ends of the flow collecting channels 1218121 along the second direction Y. The part of the support rib 1218122 extending from the end of the flow collecting channel 1218121 along the second direction Y is configured as an insertion portion 121811. The dimension of the flow collecting channel 1218121 along the first direction X is W1, and the value of W1 ranges from 4 mm to 10 mm. The side of the connecting portion 12182 facing the structural beam 1212 is provided with a protrusion 121821, and the protrusion 121821 is inserted into the heat exchange flow channel 12121. The dimension of the protrusion 121821 along the first direction X is H2, and the value of H2 ranges from 5 mm to 10 mm. The frame 1211 includes a first side beam 12111, which is connected to the flow collector member 1218 and has a first abutting surface 121111 that abuts against the flow collector member 1218 along the first direction X. Along the first direction X, the minimum distance between the heat exchange flow channel 12121 and the first abutting surface 121111 is Lmin, and the value of Lmin ranges from 5 mm to 15 mm. The heat exchange flow channels 12121 inside the plurality of structural beams 1212 are communicated in series and/or in parallel to form a heat exchange flow path, the heat exchange flow path has a first interface 12124 and a second interface 12125, one of the first interface 12124 and the second interface 12125 is configured to allow a heat exchange medium to flow in, and the other one of the first interface 12124 and the second interface 12125 is configured to allow a heat exchange medium to flow out.

In a second optional embodiment of the battery apparatus 100, referring to FIG. 6, in contrast to the first optional embodiment, the flow collector unit 12181 includes a main body portion 121812 and a tube portion 121813, the main body portion 121812 has an accommodating cavity inside, the accommodating cavity runs through both ends of the main body portion 121812 along the second direction Y, the tube portion 121813 is located in the accommodating cavity, both ends of the tube portion 121813 extend from both ends of the main body portion 121812 along the second direction Y, the part of the tube portion 121813 extending from the main body portion 121812 is configured as an insertion portion 121811, the tube portion 121813 has a flow collecting channel 1218121 inside, and the flow collecting channel 1218121 runs through both ends of the tube portion 121813, where the strength of the tube portion 121813 is greater than that of the main body portion 121812.

When the flow collector member 1218 is friction welded to the structural beam 1212 and the first side beam 12111 respectively, through provision of the insertion portion 121811 and the protrusion 121821, and the limitation of various dimensions, H1, H2, W1, and Lmin, the possibility of the heat exchange flow channel 12121 being crushed due to excessive pressure of the welding head can be reduced, the stress can be dispersed when the structural beam 1212 bears load, the stress concentration at the welding position can be reduced, and the bearing capacity of the first box body 121 can be increased. By connecting two adjacent structural beams 1212 to the flow collector unit 12181, a plurality of structural beams 1212 are arranged at intervals along the second direction Y, and the structural beams 1212 are connected to the frame 1211 through the flow collector member 1218, which can simplify the bottom structure of the box 120 and reduce the welding area; at the same time, the heat exchange flow channels 12121 of the two adjacent structural beams 1212 can be connected in series or in parallel as needed, so that the flow channels can be flexibly designed as needed. In addition, the plurality of structural beams 1212 are arranged at intervals along the second direction Y, which can also reduce the weight of the box 120 and save the use of materials.

Finally, it should be noted that: the above embodiments are merely used for illustrating rather than limiting the technical solutions of the present application. Although the present application has been described in detail with reference to the various afore-mentioned embodiments, those of ordinary skill in the art should understand that the technical solutions specified in the various aforementioned embodiments can still be modified, or some or all of the technical features therein can be equivalently substituted; and such modifications or substitutions do not make the essence of the corresponding technical solutions depart from the scope of the technical solutions of the various embodiments of the present application, and shall fall within the scope of the claims and the specification of the present application. In particular, the technical features mentioned in the various embodiments can be combined in any manner as long as there is no structural conflict. The present application is not limited to the particular embodiments disclosed herein, but rather includes all technical solutions falling within the scope of the claims.

What is claimed is:

1. A battery apparatus, comprising:
a battery cell assembly comprising a plurality of battery cells arranged along a first direction; and
a box comprising a first box body and a second box body, where the first box body and the second box body jointly define an accommodating space, the battery cell assembly is located in the accommodating space, the first box body has a flow collecting channel, the first box body comprises a frame and a plurality of structural beams, the plurality of structural beams are arranged at intervals along a second direction, the plurality of structural beams are respectively connected to the frame, the structural beams each have a heat exchange flow channel inside, the heat exchange flow channels of two adjacent structural beams are communicated through the flow collecting channel, the first direction intersects with the second direction, and the plane where the first direction and the second direction are located intersects with a height direction of the box.

2. The battery apparatus according to claim 1, wherein the first box body comprises a flow collector member, the frame comprises two first side beams spaced apart along the first direction, at least one end of the structural beam along the first direction is connected with the flow collector member, the structural beam is connected to the first side beam through the flow collector member, the flow collector member comprises at least one flow collector unit, and the flow collector unit has the flow collecting channel inside.

3. The battery apparatus according to claim 2, wherein:
the structural beam is welded to the flow collector member; and/or
the first side beam is welded to the flow collector member.

4. The battery apparatus according to claim 3, wherein:
the flow collector member further comprises a connecting portion, and both ends of the flow collector unit along the second direction are respectively connected with the connecting portions; and
an end of the structural beam along the first direction is welded to the connecting portion, and/or the first side beam is welded to the connecting portion.

5. The battery apparatus according to claim 2, wherein the flow collector member further comprises an insertion portion, both ends of the flow collector unit along the second direction are respectively provided with the insertion portions, the insertion portion at one end of the flow collector unit along the second direction is a first insertion portion, and the insertion portion at the other end of the flow collector unit along the second direction is a second insertion portion, the first insertion portion is inserted into the heat exchange flow channel of one of the two adjacent structural beams, and the second insertion portion is inserted into the heat exchange flow channel of the other one of the two adjacent structural beams.

6. The battery apparatus according to claim 5, wherein the value of the insertion depth H1 of the insertion portion into the heat exchange flow channel along the second direction ranges from 5 m to 10 mm.

7. The battery apparatus according to claim 5, wherein the flow collecting channel is one of a plurality of flow collecting channels arranged at intervals along the second direction, a support rib is formed between two adjacent flow collecting channels, the support rib extends from both ends of the flow collecting channels along the second direction, and the part of the support rib extending from the end of the flow collecting channel along the second direction is configured as the insertion portion.

8. The battery apparatus according to claim 7, wherein the value of the dimension W1 of the flow collecting channel along the first direction ranges from 4 mm to 10 mm.

9. The battery apparatus according to claim 5, wherein the flow collector unit comprises a main body portion and a tube portion, the main body portion has an accommodating cavity inside, the accommodating cavity runs through both ends of the main body portion along the second direction, the tube portion is located in the accommodating cavity, both ends of the tube portion extend from both ends of the main body portion along the second direction, the part of the tube portion extending from the main body portion is configured as the insertion portion, the tube portion has the flow collecting channel inside, and the flow collecting channel runs through both ends of the tube portion.

10. The battery apparatus according to claim 9, wherein the strength of the tube portion is greater than that of the main body portion .

11. The battery apparatus according to claim 2, wherein the flow collector member further comprises a connecting portion, both ends of the flow collector unit along the second direction are respectively connected with the connecting portions, and the connecting portions are respectively connected to the end of the structural beam and the frame.

12. The battery apparatus according to claim 11, wherein a protrusion is provided on the side of the connecting portion facing the structural beam, and the protrusion is inserted into the heat exchange flow channel.

13. The battery apparatus according to claim 12, wherein the value of the dimension H2 of the protrusion along the first direction ranges from 5 mm to 10 mm.

14. The battery apparatus according to claim 11, wherein the flow collector unit is one of a plurality of flow collector units provided, two adjacent flow collector units are spaced apart along the second direction, and the two adjacent flow collector units are connected via the connecting portion.

15. The battery apparatus according to claim 2, wherein the first side beam has a first abutting surface that abuts against the flow collector member along the first direction, along the first direction, the value of the minimum distance Lmin between the heat exchange flow channel and the first abutting surface ranges from 5 mm to 15 mm.

16. The battery apparatus according to claim 1, wherein the frame comprises two first side beams spaced apart along the first direction, the structural beam is directly welded to the first side beams, and at least one of the first side beams has the flow collecting channel inside.

17. The battery apparatus according to claim 1, wherein the heat exchange flow channels inside the plurality of structural beams are communicated in series to form a heat exchange flow path, the heat exchange flow path has a first interface and a second interface, one of the first interface and the second interface is configured to allow a heat exchange medium to flow in, and the other one of the first interface and the second interface is configured to allow a heat exchange medium to flow out.

18. The battery apparatus according to claim 1, wherein the plurality of structural beams include more than three structural beams, the heat exchange flow channels inside the plurality of structural beams are communicated in series and in parallel to form a heat exchange flow path, the heat exchange flow path has a first interface and a second interface, one of the first interface and the second interface is configured to allow a heat exchange medium to flow in, and the other one of the first interface and the second interface is configured to allow a heat exchange medium to flow out.

19. The battery apparatus according to claim 18, wherein the first box body further comprises a connecting tube, one of the two outermost structural beams along the second direction is the first structural beam, and the other one of the two outermost structural beams along the second direction is the second structural beam, and the heat exchange flow channel of the first structural beam and the heat exchange flow channel of the second structural beam are communicated in series through the connecting tube.

20. An electrical device, comprising the battery apparatus according to claim 1, wherein the battery apparatus is configured to supply electrical energy to the electrical device.
